(19) United States
(12) Patent Application Publication
(10) Pub. No.: US 2014/0352459 A1
(43) Pub. Date: Dec. 4, 2014

(54) DRIVE DEVICE, ELECTRONIC COMPONENT CARRYING DEVICE, ELECTRONIC COMPONENT INSPECTION DEVICE, ROBOT HAND, AND ROBOT

(71) Applicant: Seiko Epson Corporation, Tokyo (JP)

(72) Inventors: Akira Matsuzawa, Shiojiri (JP); Osamu Urano, Okaya (JP); Yoshiteru Nishimura, Shiojiri (JP); Masakuni Shiozawa, Chino (JP); Osamu Miyazawa, Shimosuwa-machi (JP)

(73) Assignee: Seiko Epson Corporation, Tokyo (JP)

(21) Appl. No.: 14/217,605

(22) Filed: Mar. 18, 2014

(30) Foreign Application Priority Data
May 31, 2013 (JP) 2013-115022

(51) Int. Cl. H02N 2/00; G01D 21/00; B25J 15/08

(52) U.S. Cl. CPC H02N 2/0075; B25J 15/08; G01D 21/00; Y10S 901/23; Y10S 901/38; Y10S 901/27
USPC 73/865.8; 318/112; 294/198; 74/490.03; 901/23; 901/38; 901/27

(57) ABSTRACT

A drive device includes plural moving portions, piezoelectric motors that move the moving portions, at least one drive circuit that drives the piezoelectric motors, and a connection/disconnection portion that connects and disconnects the piezoelectric motors and the drive circuit. The number of drive circuits is fewer than the number of piezoelectric motors.

### BACKGROUND

1. Technical Field

The present invention relates to a drive device, an electronic component carrying device, an electronic component inspection device, a robot hand, and a robot.

2. Related Art

A drive device which causes separate drive circuits to drive plural motors to move a movable portion is known. Such a drive device is used, for example, as a positioning device. The drive device can position a movable portion at a predetermined position by causing the drive circuits to sequentially drive the plural motors that move a movable portion in different directions. A traditional positioning device, which generally uses electromagnetic motors or pulse motors, needs a braking mechanism for each motor that holds a non-driven rotor so as to prevent the rotor from rotating.

As an alternative, a drive device using piezoelectric motors (piezoelectric actuators) has been proposed (see, for example, JP-A-2001-136760). Since the piezoelectric motors transmit vibrations generated by a piezoelectric element to a rotating portion as a frictional force and the position of the rotating portion is maintained by the frictional force even in a non-driven state, no braking mechanism is required. Therefore, in the drive device using the piezoelectric motors as disclosed in JP-A-2001-136760, a reduction in the size and weight of the device can be realized as compared with drive devices using electromagnetic motors or pulse motors.

However, in the drive device disclosed in JP-A-2001-136760, each piezoelectric motor is driven by a separate drive circuit. As such, the number of drive circuits required is equal to the number of piezoelectric motors. Therefore, there is a problem that it is difficult to further reduce the size, weight and cost of the drive device.

### SUMMARY

An advantage of some aspects of the invention is to solve at least a part of the problems described above, and the invention can be implemented as the following aspects or application examples.

An aspect of the invention is directed to a drive device including: plural moving portions; motors that move the moving portions; at least one drive circuit that drives the motors; and a connection/disconnection portion that connects and disconnects the motors and the drive circuit. The number of drive circuits is fewer than the number of motors.

According to this configuration, as the motors and the drive circuit are connected and disconnected to selectively drive the motors, the plural motors can be driven in a time division manner by the common drive circuit, thus moving the moving portions. Therefore, the number of the drive circuits can be made smaller than the number of the motors. As a result, a reduction in the size, weight and cost of the drive device can be realized.

In the drive device of the aspect of the invention, it is preferable that the motors are piezoelectric motors.

According to this configuration, the moving portions can make fine movement and the positioning accuracy of the moving portions can be improved. Also, since the piezoelectric motor has a certain braking effect at the time of a stop, the moving portions will not be easily misaligned even if an external force is applied.

In the drive device of the aspect of the invention, it is preferable that the drive device includes a braking unit that performs braking on the movement of the moving portions.

According to this configuration, the moving portions will not be easily misaligned even if a large external force is applied.

In the drive device of the aspect of the invention, it is preferable that the drive circuit is provided in a plural number.

According to this configuration, the number of motors dealt with by one drive circuit can be reduced. Therefore, the drive circuit can control one motor for a longer period of time and this enables various kinds of control.

In the drive device of the aspect of the invention, it is preferable that the moving portions have different moving directions from one another.

According to this configuration, as each motor is separately driven in a switching manner to drive each moving portion in different directions, an object can be moved to a desired position easily and accurately.

In the drive device of the aspect of the invention, it is preferable that the plural moving portions include a first moving portion, a second moving portion movable in a direction orthogonal to a moving direction of the first moving portion, and a third moving portion having a rotation axis in a direction orthogonal to each of the moving direction of the first moving portion and the moving direction of the second moving portion.

According to this configuration, each motor is separately driven in a switching manner and the first moving portion, the second moving portion and the third moving portion are moved or rotated in different directions. Therefore, an object can be moved to a desired position easily and accurately.

In the drive device of the aspect of the invention, it is preferable that the drive device includes a base portion, that the first moving portion is provided movably on the base portion, and that the third moving portion is arranged between the first moving portion and the second moving portion.

According to this configuration, an inertial force in the moving direction of the third moving portion can be reduced. The third moving portion will not be easily misaligned even if acceleration or deceleration is applied in the same direction as the moving direction of the third moving portion.

In the drive device of the aspect of the invention, it is preferable that the connection/disconnection portion is provided between each of the motors and the drive circuit.

According to this configuration, since the plural motors can be driven separately one by one, the movement of each moving portion can be controlled separately one by one. Thus, an object can be moved to a desired position easily and accurately.

In the drive device of the aspect of the invention, it is preferable that the connection/disconnection portion has a photo-MOS relay.

According to this configuration, compared with the case where the connection/disconnection portion is configured with a mechanical relay (electromagnetic relay), the operation time in connection and disconnection is shorter, the power consumption is smaller, and the service life is longer. Thus, a drive device with higher performance and high reliability can be provided.

In the drive device of the aspect of the invention, it is preferable that the connection/disconnection portion has a rotary switch.

According to this configuration, compared with the case where the connection/disconnection portion is configured with a photo-MOS relay, the rotary switch can be manually rotated to connect and disconnect the motors and the drive circuit easily, for example, even when a select signal to operate the photo-MOS relay cannot be outputted, as in maintenance or adjustment of the device.

Another aspect of the invention is directed to an electronic component carrying device including: a grip portion to grip an electronic component; plural moving portions that move the grip portion; motors that are provided on the moving portions and move the moving portions; at least one drive circuit that drives the motors; and a connection/disconnection portion that connects and disconnects the motors and the drive circuit. The number of drive circuits is fewer than the number of motors.

According to this configuration, as the motors and the drive circuit are connected and disconnected to selectively drive the motors, the plural motors can be driven in a time division manner by the common drive circuit, thus moving the moving portions. Therefore, the number of the drive circuits can be made smaller than the number of the motors. As a result, a reduction in the size, weight and cost of the electronic component carrying device can be realized.

In the electronic component carrying device of the aspect of the invention, it is preferable that the motors are piezoelectric motors.

According to this configuration, the moving portions can make fine movement and the positioning accuracy of the moving portions can be improved. Also, since the piezoelectric motor has a certain braking effect at the time of a stop, the moving portions will not be easily misaligned even if an external force is applied.

In the electronic component carrying device of the aspect of the invention, it is preferable that the plural moving portions include a first moving portion, a second moving portion movable in a direction orthogonal to a moving direction of the first moving portion, and a third moving portion having a rotation axis in a direction orthogonal to each of the moving direction of the first moving portion and the moving direction of the second moving portion.

According to this configuration, each motor is separately driven in a switching manner and the first moving portion, the second moving portion and the third moving portion are moved or rotated in different directions. Therefore, the grip portion can be moved to a desired position easily and accurately.

In the electronic component carrying device of the aspect of the invention, it is preferable that the electronic component carrying device includes a base portion, that the first moving portion is provided movably on the base portion, and that the third moving portion is arranged between the first moving portion and the second moving portion.

According to this configuration, an inertial force in the moving direction of the third moving portion can be reduced. The third moving portion will not be easily misaligned even if acceleration or deceleration is applied in the same direction as the moving direction of the third moving portion.

Still another aspect of the invention is directed to an electronic component inspection device including: an inspection portion that inspects an electronic component; a grip portion to grip the electronic component; plural moving portions that move the grip portion; motors that are provided on the moving portions and move the moving portions; at least one drive circuit that drives the motors; and a connection/disconnection portion that connects and disconnects the motors and the drive circuit. The number of drive circuits is fewer than the number of motors.

According to this configuration, as the motors and the drive circuit are connected and disconnected to selectively drive the motors, the plural motors can be driven in a time division manner by a common drive circuit, thus moving the moving portions. Therefore, the number of the drive circuits can be made smaller than the number of the motors. As a result, a reduction in the size, weight and cost of the electronic component inspection device can be realized.

In the electronic component inspection device of the aspect of the invention, it is preferable that the motors are piezoelectric motors.

According to this configuration, the moving portions can make fine movement and the positioning accuracy of the moving portions can be improved. Also, since the piezoelectric motor has a certain braking effect at the time of a stop, the moving portions will not be easily misaligned even if an external force is applied.

In the electronic component inspection device of the aspect of the invention, it is preferable that the plural moving portions include a first moving portion, a second moving portion movable in a direction orthogonal to a moving direction of the first moving portion, and a third moving portion having a rotation axis in a direction orthogonal to each of the moving direction of the first moving portion and the moving direction of the second moving portion.

According to this configuration, each motor is separately driven in a switching manner and the first moving portion, the second moving portion and the third moving portion are moved or rotated in different directions. Therefore, the grip portion can be moved to a desired position easily and accurately.

In the electronic component inspection device of the aspect of the invention, it is preferable that the electronic component inspection device includes a base portion, that the first moving portion is provided movably on the base portion, and that the third moving portion is arranged between the first moving portion and the second moving portion.

According to this configuration, an inertial force in the moving direction of the third moving portion can be reduced. The third moving portion will not be easily misaligned even if acceleration or deceleration is applied in the same direction as the moving direction of the third moving portion.

Yet another aspect of the invention is directed to a robot hand including: plural rotatable finger portions; motors that rotate the finger portions; at least one drive circuit that drives the motors; and a connection/disconnection portion that connects and disconnects the motors and the drive circuit. The number of drive circuits is fewer than the number of motors.

According to this configuration, as the motors and the drive circuit are connected and disconnected to selectively drive the motors, the plural motors can be driven in a time division manner by the common drive circuit, thus moving the finger portions. Therefore, the number of the drive circuits can be made smaller than the number of the motors. As a result, a reduction in the size, weight and cost of the robot hand can be realized.

In the robot hand of the aspect of the invention, it is preferable that the motors are piezoelectric motors.

According to this configuration, the finger portions can make fine movement and the positioning accuracy of the finger portions can be improved. Also, since the piezoelectric motor has a certain braking effect at the time of a stop, the finger portions will not be easily misaligned even if an external force is applied.

Still yet another aspect of the invention is directed to a robot including: plural rotatable arm portions; motors that move the arm portions; at least one drive circuit that drives the motors; and a connection/disconnection portion that connects and disconnects the motors and the drive circuit. The number of drive circuits is fewer than the number of motors.

According to this configuration, as the motors and the drive circuit are connected and disconnected to selectively drive the motors, the plural motors can be driven in a time division manner by a common drive circuit, thus rotating the arm portions. Therefore, the number of the drive circuits can be made smaller than the number of the motors. As a result, a reduction in the size, weight and cost of the robot can be realized.

In the robot of the aspect of the invention, it is preferable that the motors are piezoelectric motors.

According to this configuration, the arm portions can make fine movement and the positioning accuracy of the arm portions can be improved. Also, since the piezoelectric motor has a certain braking effect at the time of a stop, the arm portions will not be easily misaligned even if an external force is applied.

### BRIEF DESCRIPTION OF THE DRAWINGS

Embodiments of the invention will be described with reference to the accompanying drawings, wherein like numbers reference like elements.

FIG. 1 is a block diagram showing the schematic configuration of a drive device according to a first embodiment.

FIG. 2 is a schematic view showing the configuration of a piezoelectric motor used in the drive device according to the first embodiment.

FIG. 3 is a block diagram showing the configuration of the drive device according to the first embodiment.

FIG. 4 is a block diagram showing the configuration of a drive circuit according to the first embodiment.

FIGS. 5A to 5E illustrate a drive control method for the drive device according to the first embodiment.

FIG. 6 is a schematic view showing the configuration of a piezoelectric motor used in a drive device according to a second embodiment.

FIG. 7 is a block diagram showing the configuration of the drive device according to the second embodiment.

FIG. 8 is a block diagram showing the configuration of a drive circuit according to the second embodiment.

FIGS. 9A to 9C illustrate an example of an electronic component according to a third embodiment.

FIG. 10 is a schematic plan view showing an electronic component carrying device and an electronic component inspection device according to the third embodiment.

FIG. 11 is a cross-sectional view of an individual socket for inspection provided in the electronic component inspection device shown in FIG. 10.

FIG. 12 is a partial cross-sectional view showing a hand unit of a supply robot provided in the electronic component inspection device shown in FIG. 10.

FIG. 13 is a perspective view showing a hand unit of an inspection robot provided in the electronic component inspection device shown in FIG. 10.

FIG. 14 is an exploded perspective view showing the hand unit of the inspection robot provided in the electronic component inspection device shown in FIG. 10.

FIG. 15 is a view showing a moving mechanism of the hand unit of the inspection robot provided in the electronic component inspection device shown in FIG. 10, taken along a plane perpendicular to an X-direction.

FIG. 16 is a block diagram showing the schematic configuration of a positioning mechanism provided in the electronic component inspection device shown in FIG. 10.

FIG. 17 is a plan view illustrating an inspection procedure for an electronic component by the electronic component inspection device shown in FIG. 10.

FIG. 18 is a plan view illustrating an inspection procedure for an electronic component by the electronic component inspection device shown in FIG. 10.

FIG. 19 is a plan view illustrating an inspection procedure for an electronic component by the electronic component inspection device shown in FIG. 10.

FIG. 20 is a plan view illustrating an inspection procedure for an electronic component by the electronic component inspection device shown in FIG. 10.

FIG. 21 is a plan view illustrating an inspection procedure for an electronic component by the electronic component inspection device shown in FIG. 10.

FIG. 22 is a plan view illustrating an inspection procedure for an electronic component by the electronic component inspection device shown in FIG. 10.

FIG. 23 is a plan view illustrating an inspection procedure for an electronic component by the electronic component inspection device shown in FIG. 10.

FIG. 24 is a plan view illustrating an inspection procedure for an electronic component by the electronic component inspection device shown in FIG. 10.

FIG. 25 is a plan view illustrating an inspection procedure for an electronic component by the electronic component inspection device shown in FIG. 10.

FIGS. 26A and 26B are schematic views showing the structures of a robot hand and of a robot according to a fourth embodiment.

FIGS. 27A and 27B are schematic views showing the configurations of piezoelectric motors used in a drive device according to a fifth embodiment.

FIG. 28 is a schematic view showing a rotary switch in a drive device according to a sixth embodiment.

### DESCRIPTION OF EXEMPLARY EMBODIMENTS

Hereinafter, a drive device, an electronic component carrying device, an electronic component inspection device, a robot hand and a robot according to the invention will be described in detail, based on preferred embodiments shown in the accompanying drawings. In the reference drawings, the dimensional proportion, angle and the like of each component may vary, in order to facilitate understanding of the configurations.

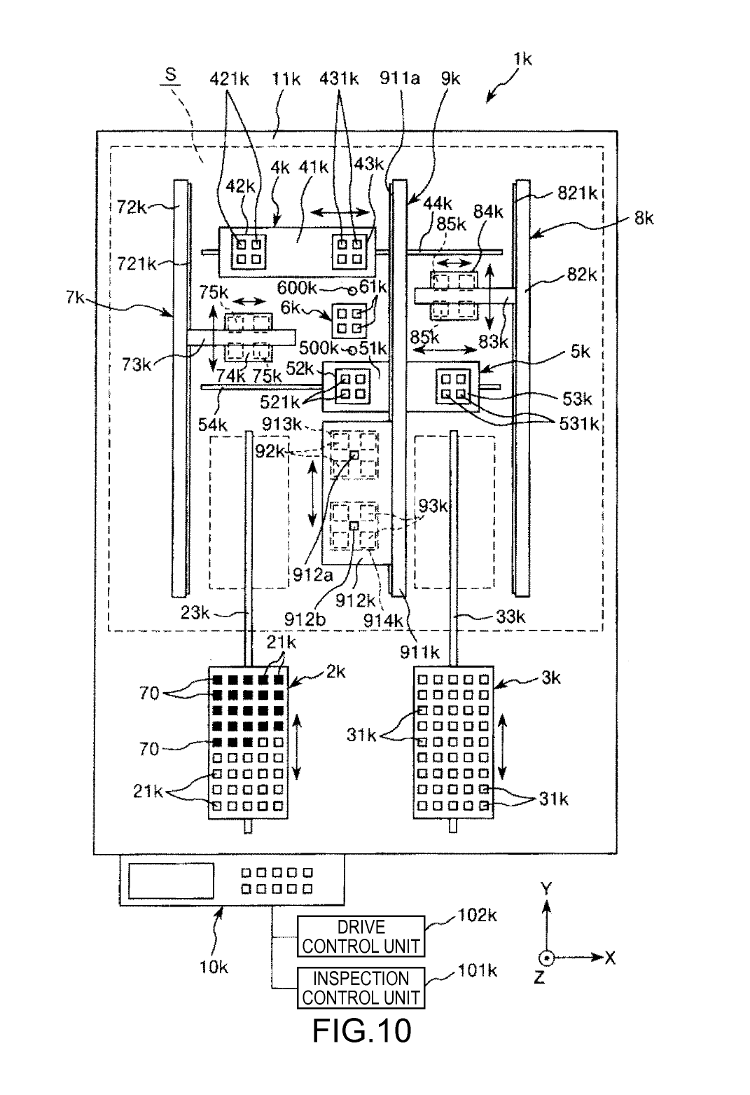

In the embodiments below, three axes orthogonal to one another are referred to as an X-axis, Y-axis and Z-axis, as shown in FIG. 10. A plane prescribed by the X-axis and Y-axis is referred to as an “XY plane”. A plane prescribed by the Y-axis and Z-axis is referred to as a “YZ plane”. A plane prescribed by the X-axis and Z-axis is referred to as a “XZ plane”. A direction parallel to the X-axis is referred to as an “X-direction (first direction)”. A direction parallel to the Y-axis is referred to as a “Y-direction (second direction)”. A direction parallel to the Z-axis is referred to as a “Z-direction (third direction)”. In the X-direction, Y-direction and Z-direction, the distal end side of an arrow is called a (+) side, whereas the proximal end side of the arrow is called a (−) side.

### First Embodiment

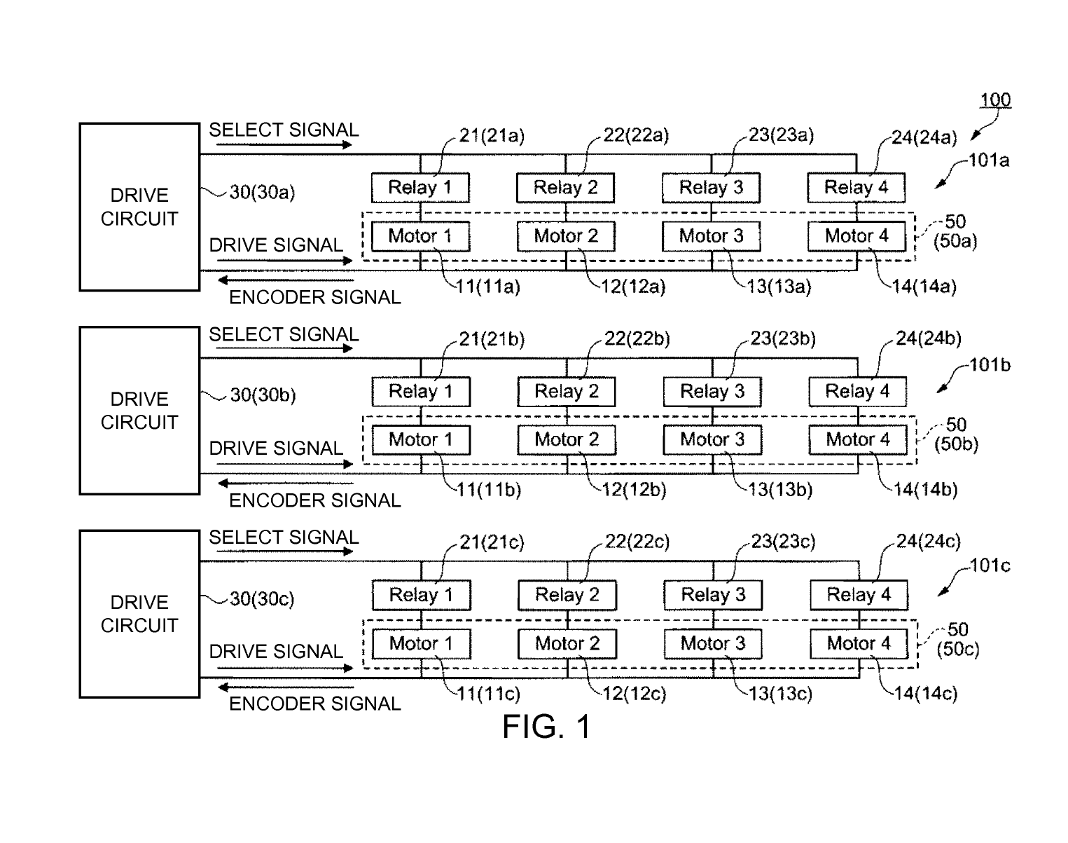

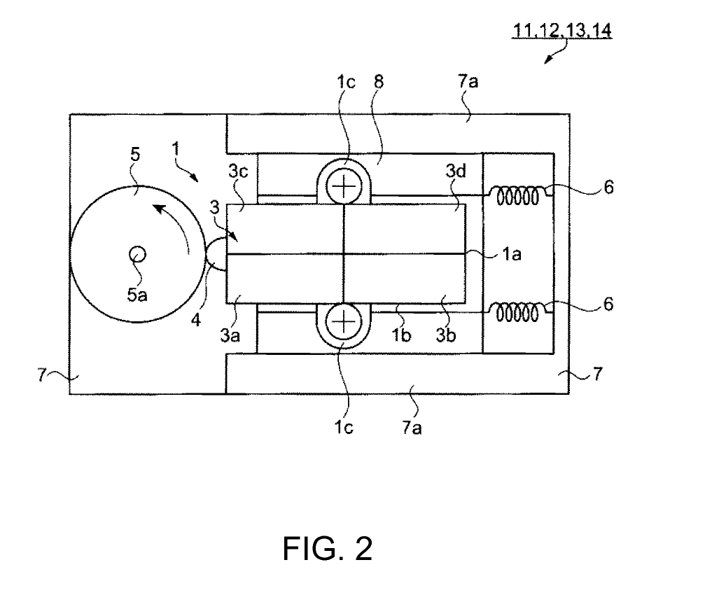

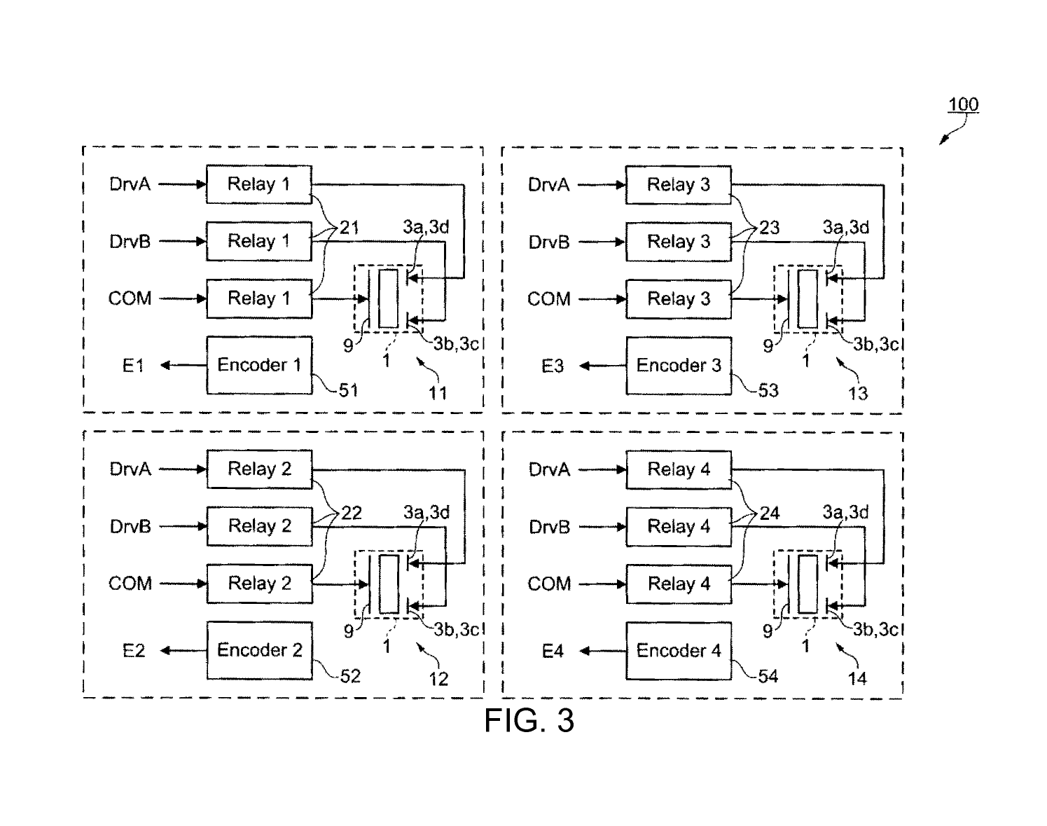

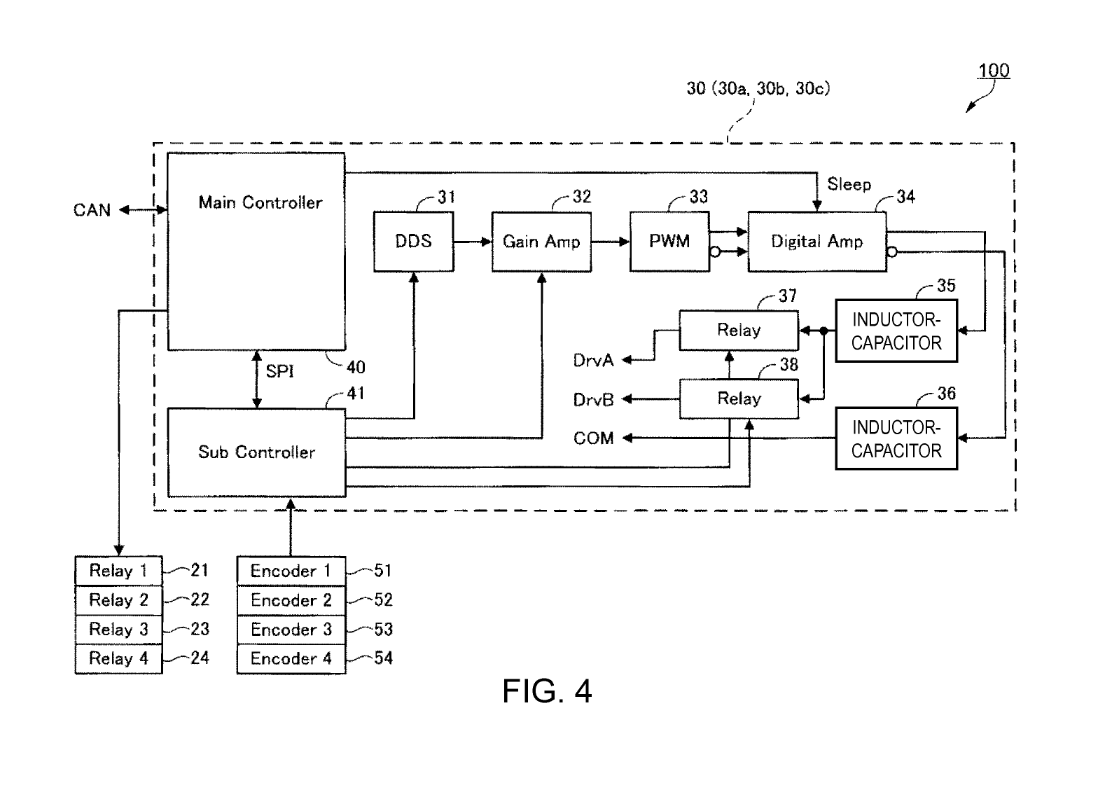

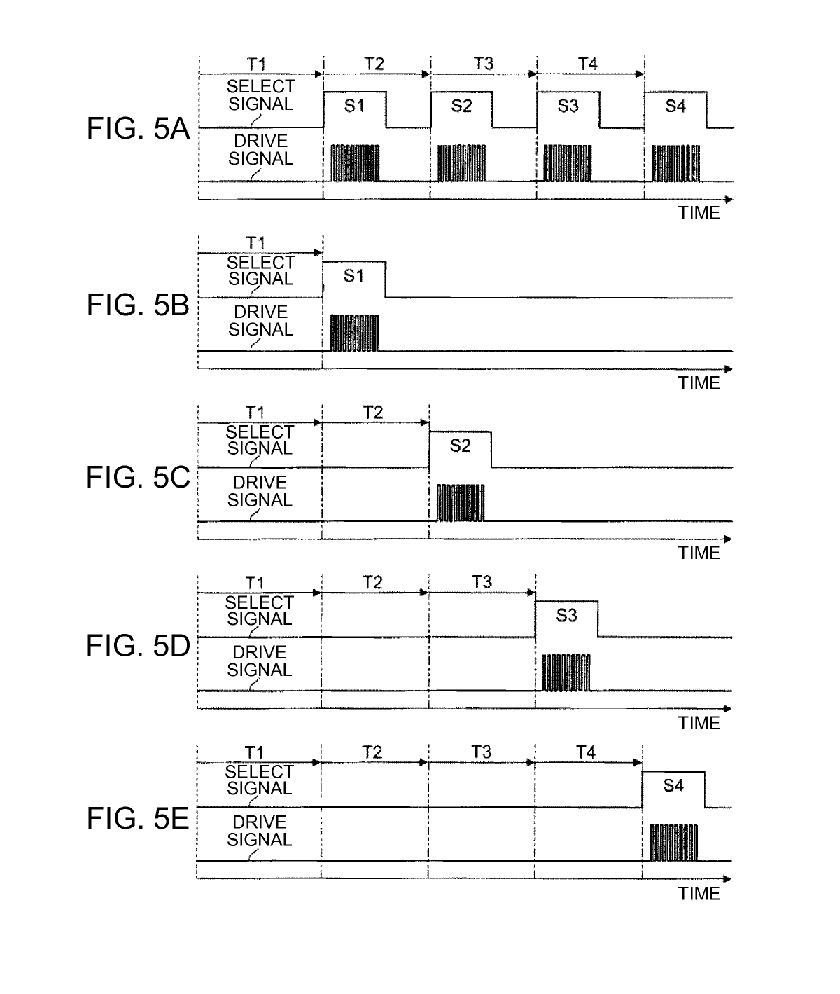

FIG. 1 is a block diagram showing the schematic configuration of a drive device according to a first embodiment. FIG. 2 is a schematic view showing the configuration of a piezoelectric motor used in the drive device according to the first embodiment. FIG. 3 is a block diagram showing the configuration of the drive device according to the first embodiment. FIG. 4 is a block diagram showing the configuration of a drive circuit according to the first embodiment. FIGS. 5A to 5E illustrate a drive control method for the drive device according to the first embodiment.

### Drive Device

First, the schematic configuration of the drive device according to the first embodiment will be described. FIG. 1 is a block diagram showing the schematic configuration of the drive device according to the first embodiment. As shown in FIG. 1, a drive device 100 according to the first embodiment includes three drive units 101a, 101b, 101c.

Each of the drive units 101a, 101b, 101c has the same configuration. The letters a, b, c at the end of the reference numbers associate each drive unit 101 with a movable portion 50, drive circuit 30, relays 21, 22, 23, 24 as connection/disconnection portions, and piezoelectric motors 11, 12, 13, 14 that are provided in the corresponding drive unit 101.

That is, the drive device 100 includes movable portions 50a, 50b, 50c, drive circuits 30a, 30b, 30c, piezoelectric motors 11a, 11b, 11c, 12a, 12b, 12c, 13a, 13b, 13c, 14a, 14b, 14c, and relays 21a, 21b, 21c, 22a, 22b, 22c, 23a, 23b, 23c, 24a, 24b, 24c. In the following description, the letters a, b, c at the end of the reference numbers are omitted.

In each drive unit 101, the movable portion 50 is provided with four piezoelectric motors 11, 12, 13, 14. The relays 21, 22, 23, 24 are provided for the piezoelectric motors 11, 12, 13, 14, respectively. That is, the piezoelectric motors 11, 12, 13, 14 are connected to the relays 21, 22, 23, 24, respectively, on a one-to-one basis, and connected to the drive circuit 30 for driving the piezoelectric motors 11, 12, 13, 14 via the relays 21, 22, 23, 24.

The relays 21, 22, 23, 24 are configured, for example, as photo-MOS relays. The relays 21, 22, 23, 24 operate based on a select signal outputted from the drive circuit 30 and electrically connect or cut off (disconnect) each of the piezoelectric motors 11, 12, 13, 14 to and from the drive circuit 30. A drive signal from the drive circuit 30 is selectively supplied to the piezoelectric motor electrically connected to the drive circuit 30 by the switching of the relays 21, 22, 23, 24, of the piezoelectric motors 11, 12, 13, 14. Also, an encoder signal is fed back to the drive circuit 30 by the operation of the piezoelectric motor supplied with the drive signal from the drive circuit 30, of the piezoelectric motors 11, 12, 13, 14.

The drive device 100 is a multi-axis drive device having 12 axes where, in each of the three drive units 101a, 101b, 101c, one of the four (four-axis) piezoelectric motors 11, 12, 13, 14 is selectively connected to the drive circuit 30 and driven in a time division manner by the switching of the relays 21, 22, 23, 24, thereby moving each of the three movable portions 50 to a desired position. A drive control method for the drive device 100 will be described later.

It should be noted that, while photo-MOS relays are used for the relays 21, 22, 23, 24 in this embodiment, mechanical relays (electromagnetic relays) may also be used. However, a photo-MOS relay has a shorter operation (response) time between connection and cut-off than a mechanical relay and therefore can realize fast switching, small power consumption and a long service life. Therefore, it is preferable to use photo-MOS relays for the relays 21, 22, 23, 24.

### Piezoelectric Motor

Next, the configuration of the piezoelectric motors 11, 12, 13, 14 will be described. FIG. 2 is a schematic view showing the configuration of the piezoelectric motor used in the drive device according to the first embodiment. FIG. 3 is a block diagram showing the configuration of the drive device according to the first embodiment.

The piezoelectric motors 11, 12, 13, 14 have the same configuration. As shown in FIG. 2, each of the piezoelectric motors 11, 12, 13, 14 has an oscillating body 1, a driven member 5, a holding member 8, an urging spring 6, and a base 7. The oscillating body 1, the driven member 5, the holding member 8 and the urging spring 6 are installed on the base 7. Here, an example where the driven member 5 is a rotor that is rotationally driven is described.

As viewed in the orientation shown in FIG. 2, the oscillating body 1 is shaped substantially as a rectangle having a short side 1a and a long side 1b. In the following description, a direction along the short side 1a is called a lateral direction, whereas a direction along the long side 1b is called a longitudinal direction. The oscillating body 1 is formed, for example, by a plate-shaped piezoelectric element. The oscillating body 1 may also be a multilayer body in which a piezoelectric element and an oscillating plate are stacked on each other.

The piezoelectric element is made of a piezoelectric material having an electromechanical conversion effect, for example, a metal oxide material having the perovskite structure that is expressed by the general formula ABO₃. Such a metal oxide may be lead zirconate titanate (Pb(Zr,Ti)O₃: PZT), lithium niobate (LiNbO₃) or the like.

An electrode 3 made of a conductive metal such as Ni, Au or Ag is provided on a surface of the oscillating body 1. The electrode 3 is substantially quadrisected by groove portions formed in a central section in the lateral direction of the oscillating body 1 and in a central section in the longitudinal direction. Thus, the electrode 3 is divided into four electrode portions 3a, 3b, 3c, 3d that are electrically separated from one another as individual electrodes. Also, a common electrode 9 (see FIG. 3) is provided on the opposite surface of the oscillating body 1.

Of the four electrode portions of the electrode 3, the electrode portions 3a, 3d, paired and arranged diagonally to each other, function as a first bending oscillation electrode. The electrode portions 3c, 3b, paired and arranged on the diagonal intersecting the diagonal of the electrode portions 3a, 3d, function as a second bending oscillation electrode. Each area where the electrode portions 3a, 3d are arranged and the area where the electrode portions 3c, 3b are arranged is a bending oscillation excitation area that excites bending oscillation of the oscillating body 1 in the lateral direction.

The oscillating body 1 has a sliding portion (protrusion) 4 that is extended to protrude toward the driven member 5 and abuts against the lateral surface (circumferential surface) of the driven member 5. The oscillating body 1 also has a pair of arm portions 1c that is extended outward on both sides in the lateral direction. Each of the arm portions 1c is provided with a through-hole that penetrates the arm portion 1c in the direction of thickness, and the arm portion 1c is secured to the holding member 8 via a screw inserted in the through-hole. Thus, the oscillating body 1 is held in a state where the oscillating body 1 can perform bending oscillation about the arm portions 1c as reference points, relative to the holding members 8.

The driven member 5 is disc-shaped and arranged on the side where the sliding portion 4 of the oscillating body 1 is provided. The driven member 5 is held to be rotatable about a bar-like axis 5a provided upright on the base 7. In each of the piezoelectric motors 11, 12, 13, 14, encoders 51, 52, 53, 54 (see FIG. 3) are provided at a position near the driven member 5. The encoders 51, 52, 53, 54 feed encoder signals E1, E2, E3, E4 based on the position and rotation speed of the driven member 5, back to the drive circuit 30.

The base 7 has a pair of slide portions 7a extending along the longitudinal direction on both outer sides of the lateral direction of the oscillating body 1. The holding members 8 are supported on the base 7 in such a way that the holding members 8 are slidable along the slide portions 7a.

The urging spring 6 is installed between the side opposite to the driven member 5, of the holding member 8, and the base 7. The urging spring 6 urges the oscillating body 1 toward the driven member 5 via the holding member 8. This urging force causes the sliding portion 4 to abut against the driven member 5 with a predetermined force. The urging force of the urging spring 6 is suitably set so that an appropriate frictional force is generated between the driven member 5 and the sliding portion 4. Thus, the oscillation of the oscillating body 1 is efficiently transmitted to the driven member 5 via the sliding portion 4.

When a common signal (COM shown in FIG. 3) is supplied to the common electrode 9 from the drive circuit 30 (see FIG. 1) and a drive signal (DrvA shown in FIG. 3) is supplied to the electrode portions 3a, 3d as the first bending oscillation electrode, bending oscillation to bend along the lateral direction is excited in the oscillating body 1. This bending oscillation causes the sliding portion 4 to slide, following a clockwise elliptical trajectory. This causes the driven member 5 to rotate counterclockwise, as indicated by an arrow in FIG. 2.

When a common signal (COM) is supplied to the common electrode 9 and a drive signal (DrvB shown in FIG. 3) is supplied to the electrode portions 3c, 3b as the second bending oscillation electrode, bending oscillation to bend along the lateral direction is excited in the oscillating body 1. This bending oscillation causes the sliding portion 4 to slide, following a counterclockwise elliptical trajectory. This causes the driven member 5 to rotate clockwise, as opposed to the arrow in FIG. 2.

In this manner, in the piezoelectric motors 11, 12, 13, 14, the driven member 5 can be rotated both counterclockwise and clockwise by switching between the case where the first bending oscillation electrode (electrode portions 3a, 3d) is selected and the case where the second bending oscillation electrode (electrode portions 3c, 3b) is selected when a drive signal is supplied between the common electrode 9 and the electrode portions 3a, 3b, 3c, 3d from the drive circuit 30. Thus, the direction in which the movable portion 50 (see FIG. 1) is moved can be switched between forward direction and backward direction.

The driven member 5 is not limited to the above rotationally driven rotor. The driven member 5 may also be a linear-driven member that is linearly driven and the driving direction of the driven member 5 can be arbitrarily configured. In the case where the driven member 5 is a linear-driven member, the direction of linear driving of the driven member 5 can be switched between forward direction and backward direction by switching between the first bending oscillation electrode (electrode portions 3a, 3d) and the second bending oscillation electrode (electrode portions 3c, 3b).

As shown in FIG. 3, of the piezoelectric motors 11, 12, 13, 14, only the piezoelectric motor electrically connected to the drive circuit 30 by the relays 21, 22, 23, 24 is supplied with the drive signal (DrvA or DrvB) and the common signal (COM) for the bending oscillation electrode and thus driven. The piezoelectric motor electrically cut off from the drive circuit 30 by the relays 21, 22, 23, 24 is in a non-driven state.

In the non-driven state, the driven member 5 is held at a position where the driven member 5 has stopped rotating, by a frictional force acting between the driven member 5 and the sliding portion 4. Therefore, the piezoelectric motors 11, 12, 13, 14 do not need a braking mechanism that would be provided for each motor so as to prevent the rotor from rotating in the non-driven state, as an electromagnetic motor or pulse motor. Therefore, using the piezoelectric motors 11, 12, 13, 14, a reduction in the size, weight and cost of the drive device 100 can be realized.

The piezoelectric motors 11, 12, 13, 14 may further include an acceleration/deceleration mechanism that accelerates or decelerates rotations of the driven member 5 and transmits the accelerated or decelerated rotations. The provision of the acceleration/deceleration mechanism enables easy acceleration or deceleration of the rotation speed of the driven member 5 to a desired rotation speed.

### Drive Circuit

Next, the schematic configuration of the drive circuit according to the first embodiment will be described. FIG. 4 is a block diagram showing the configuration of the drive circuit according to the first embodiment. As shown in FIG. 4, the drive circuit 30 (30a, 30b, 30c) includes a main controller 40, a sub controller 41, an oscillator 31, a gain amplifier 32, a PWM unit 33, a digital amplifier 34, inductor-capacitors 35, 36, and relays 37, 38.

The main controller 40 includes a CPU (central processing unit). The main controller 40 is connected to a control device (not shown) that controls the entire system including the drive device 100, via a CAN (controller area network). The main controller 40 controls operations of the drive device 100 such as switching between the piezoelectric motors 11, 12, 13, 14 via the relays 21, 22, 23, 24 and thus driving the piezoelectric motors 11, 12, 13, 14 in a time division manner, based on an instruction from the control device.

The sub controller 41 includes a logic IC and FPGA (field programmable gate array) or the like. The sub controller 41 is connected to the main controller 40 via an (serial peripheral interface). The sub controller 41 controls the frequency of a signal generated by the oscillator 31, the amplification rate of the gain amplifier 32, the switching of the relays 37, 38 and the like, based on an instruction from the main controller 40. The sub controller 41 also detects the position and rotation speed of the driven members 5 of the piezoelectric motors 11, 12, 13, 14, based on encoder signals (E1, E2, E3, E4 shown in FIG. 3) fed back from the encoders 51, 52, 53, 54.

The oscillator 31 includes a DDS (direct digital synthesizer) or the like. The oscillator 31 generates a signal as the basis of the drive signal supplied to the oscillating bodies 1 of the piezoelectric motors 11, 12, 13, 14. The signal generated by the oscillator 31 is converted to an analog signal by a DA converter. The oscillator 31 also adjusts the frequency of the drive signal, based on an instruction from the sub controller 41.

The gain amplifier 32 includes, for example, a digital potentiometer and an operational amplifier. The gain amplifier 32 amplifies the analog signal from the oscillator 31 through digital control. The gain amplifier 32 also adjusts the voltage value of the drive signal, based on an instruction from the sub controller 41.

The PWM unit 33 includes a PWM (pulse width modulation) circuit. The PWM unit 33 changes the duty ratio of the pulse in the input signal from the gain amplifier 32 and thereby performs equivalent analog control.

The digital amplifier 34 includes a MOS transistor H-bridge circuit and functions as a digital amplifier when used together with the PWM unit 33. The digital amplifier 34 amplifies the power of the signal from the PWM unit 33 and thus performs switching. When a “Sleep” instruction is given from the main controller 40, the function of amplifying the power and performing switching is turned off.

The inductor-capacitors 35, 36 shape the waveform of the drive signal outputted from the digital amplifier 34 into a sine wave. The inductor-capacitors 35, 36 also function as a filter circuit, an alignment circuit for the piezoelectric motors 11, 12, 13, 14, a booster circuit and the like.

From the inductor-capacitor 35, the drive signal (DrvA) is outputted to the first bending oscillation electrode (electrode portions 3a, 3d shown in FIG. 2) in the piezoelectric motors 11, 12, 13, 14 via the relay 37, and the drive signal (DrvB) is outputted to the second bending oscillation electrode (electrode portions 3c, 3b shown in FIG. 2) via the relay 38. From the inductor-capacitor 36, the common signal (COM) is outputted to the common electrode 9 (see FIG. 3) in the piezoelectric motors 11, 12, 13, 14.

The relays 37, 38 include photo-MOS relays. The relays 37, 38 operate based on an instruction from the sub controller 41, and switch between the state where the first bending oscillation electrode (electrode portions 3a, 3d) and the second bending oscillation electrode (electrode portions 3c, 3b) are electrically connected to the inductor-capacitor 35 and the state where these electrodes are electrically disconnected from the inductor-capacitor 35. As the relays 37, 38 are switched to select the first bending oscillation electrode (electrode portions 3a, 3d) or the second bending oscillation electrode (electrode portions 3c, 3b), the driven member 5 in the piezoelectric motors 11, 12, 13, 14 rotates counterclockwise or clockwise.

### Drive Control Method

Next, a drive control method for the drive device according to the first embodiment will be described. FIGS. 5A to 5E illustrate the drive control method for the drive device according to the first embodiment.

As described above with reference to FIG. 1, in each of the drive units 101a, 101b, 101c, a select signal and a drive signal are outputted to the relays 21, 22, 23, 24 and the piezoelectric motors 11, 12, 13, 14 from the drive circuit 30. FIG. 5A schematically shows the configuration of the select signal and the drive signal outputted to the relays 21, 22, 23, 24 and the piezoelectric motors 11, 12, 13, 14 from the drive circuit 30.

As shown in FIG. 5A, the select signal includes signals S1, S2, S3, S4 sequentially emerging in a time division manner. The signal S1 emerges, for example, after the lapse of a time period T1 from a reference time point such as the start of operation. The signal S2 emerges after the lapse of a time period T2 following the time period T1. The signal S3 emerges after the lapse of a time period T3 following the time period T2. The signal S4 emerges after the lapse of a time period T4 following the time period T3. Also, the drive signal is synchronized with the signals S1, S2, S3, S4 and outputted corresponding to the duration of the signals S1, S2, S3, S4.

The signal S1 is a signal that turns the relay 21 into a connected state. Similarly, the signals S2, S3, S4 are signals that individually turn the relays 22, 23, 24, respectively, into a connected state. Of the relays 21, 22, 23, 24, the relay designated by the select signal (signals S1, S2, S3, S4) turns into the connected state and the other relays are in a disconnected state. Therefore, of the piezoelectric motors 11, 12, 13, 14, only the piezoelectric motor corresponding to the relay that is turned into the connected state on the basis of the select signal is selectively electrically connected to the drive circuit 30.

As shown in FIG. 5B, after the lapse of the time period T1, the relay 21 designated by the select signal (signal S1) turns into the connected state and only the piezoelectric motor is electrically connected to the drive circuit 30. Therefore, the drive signal is supplied only to the piezoelectric motor 11. As shown in FIG. 5C, after the lapse of the time period T2 following the time period T1, the relay 22 designated by the select signal (signal S2) turns into the connected state and only the piezoelectric motor 12 is electrically connected to the drive circuit 30. Therefore, the drive signal is supplied only to the piezoelectric motor 12.

Similarly, after the lapse of the time period T3, as shown in FIG. 5D, the relay 23 turns into the connected state and the drive signal is supplied to the piezoelectric motor 13. After the lapse of the time period T4, as shown in FIG. 5E, the relay 24 turns into the connected state and the drive signal is supplied to the piezoelectric motor 14. In this manner, the four piezoelectric motors 11, 12, 13, 14 can be sequentially driven in a time division manner by the single drive circuit 30. Also, with this configuration, the wire connecting the drive circuit 30 can be shared among the four piezoelectric motors 11, 12, 13, 14.

In this case, by supplying the select signals and the drive signals synchronously in the three drive units 101a, 101b, 101c, it is possible to synchronize the driving of the piezoelectric motors 11, 12, 13, 14 in each drive unit. That is, the movable portions 50a, 50b, 50c shown in FIG. 1 can be moved synchronously.

Here, the directions in which the movable portion (50a, 50b, 50c) shown in FIG. 1 is moved by the four piezoelectric motors 11, 12, 13, 14 may be the same or different from each other. For example, if the moving directions by the piezoelectric motors 11, 12, 13, 14 are the three directions orthogonal to one another, that is, the X-direction, Y-direction and Z-direction, and a θ-direction of rotation (pivoting) about the Z-direction as a rotation axis (pivot), the movable portion 50 can be sequentially moved in the X-direction, Y-direction, Z-direction and θ-direction to a desired position, by switching the relays 21, 22, 23, 24 to sequential drive the piezoelectric motors 11, 12, 13, 14. In this case, the movable portion 50 includes a moving portion that moves an object in the X-direction, a moving portion that moves the object in the Y-direction, a moving portion that moves the object in the Z-direction, and a moving portion that moves the object in the θ-direction, and the individual moving portions are provided with the piezoelectric motors 11, 12, 13, 14, respectively. The individual moving portions move as the respective piezoelectric motors 11, 12, 13, 14 are driven.

Alternatively, if the speed of moving the movable portion 50 is reduced (the moving distance is reduced) by an acceleration/deceleration mechanism in order of the piezoelectric motors 11, 12, 13, 14, positioning of the movable portion 50 can be finely carried out stepwise by switching the relays 21, 22, 23, 24 to sequentially drive the piezoelectric motors 11, 12, 13, 14.

It should be noted that the number of drive units provided in the drive device 100 and the number of piezoelectric motors connected to one drive circuit 30 are not limited to the foregoing. Also, plural piezoelectric motors may be connected to one relay, and electrical connection and disconnection between these plural motors and the drive circuit 30 may be carried out at the same time.

As described above, the configuration of the drive device 100 according to the first embodiment has the following effects.

1. The relays 21, 22, 23, 24 provided between the piezoelectric motors 11, 12, 13, 14 and the drive circuit 30 electrically connect or cut off at least one of the piezoelectric motors 11, 12, 13, 14 to the drive circuit 30. Therefore, as the piezoelectric motor electrically connected to the drive circuit 30 is switched by the relays 21, 22, 23, 24 and selectively driven, the plural piezoelectric motors 11, 12, 13, 14 can be driven in a time division manner by the common drive circuit 30. Therefore, the number of the drive circuit 30 and the number of wires can be made smaller than the number of the piezoelectric motors 11, 12, 13, 14. Also, since the piezoelectric motors are used, a braking mechanism that would be provided for each motor is not required or a braking mechanism with lower braking capability can be applied, compared with the case where electromagnetic motors or pulse motors are used. As a result, a reduction in the size, weight and cost of the drive device 100 can be realized. Moreover, since the number of wires can be made smaller than the number of the piezoelectric motors 11, 12, 13, 14, a load on the movable portion 50 due to the weight of the wires and the bundle of the wires can be reduced. Thus, the positioning accuracy of the movable portion 50 can be improved.

2. If the moving directions by the respective piezoelectric motors 11, 12, 13, 14 are the three directions orthogonal to one another, that is, the X-direction, Y-direction and Z-direction, and the θ-direction of rotation about the Z-direction as a rotation axis, an operation to move the piezoelectric motors 11, 12, 13, 14 individually and move the movable portion 50 in the different directions, that is, the X-direction, Y-direction, Z-direction and θ-direction can be carried out individually by switching the relays 21, 22, 23, 24. This enables easy and accurate movement of the movable portion 50 to a desired position.

3. Since the relays 21, 22, 23, 24 are provided for the piezoelectric motors 11, 12, 13, 14, respectively, the plural piezoelectric motors 11, 12, 13, 14 can be individually driven one by one by the common drive circuit 30.

4. Since the relays 21, 22, 23, 24 include photo-MOS relays, the operation time in connection and disconnection is shorter, the power consumption is smaller and the service life is longer than in the case where mechanical relays (electromagnetic relays) are used. Thus, the drive device 100 with higher performance and high reliability can be provided.

### Second Embodiment

### Drive Device

Next, a drive device according to a second embodiment will be described. The drive device according to the second embodiment is different from the first embodiment in that longitudinal oscillation is excited as well as bending oscillation in the oscillating body of the piezoelectric motor. However, the other configurations are substantially the same. Hereinafter, this embodiment is described mainly in terms of the difference from the foregoing embodiment, and explanation of similar elements is omitted.

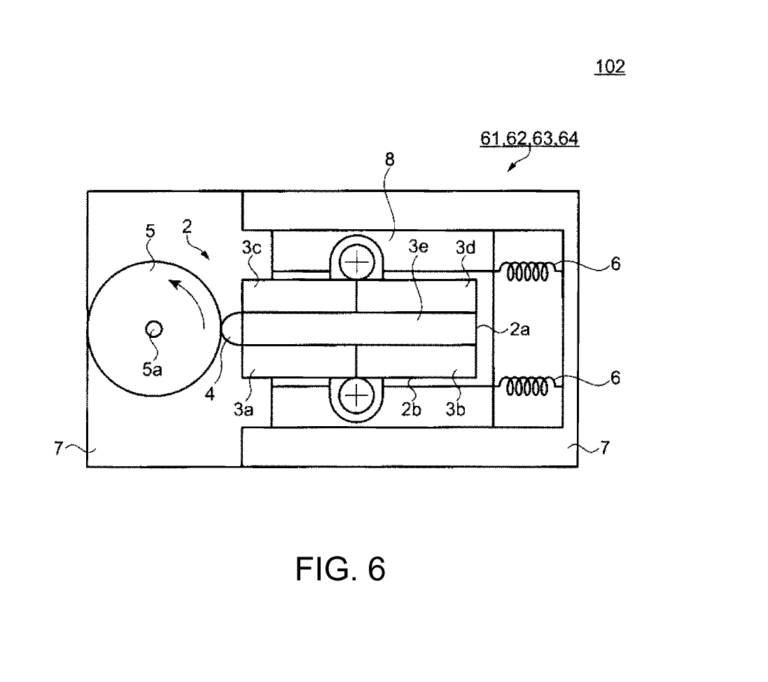

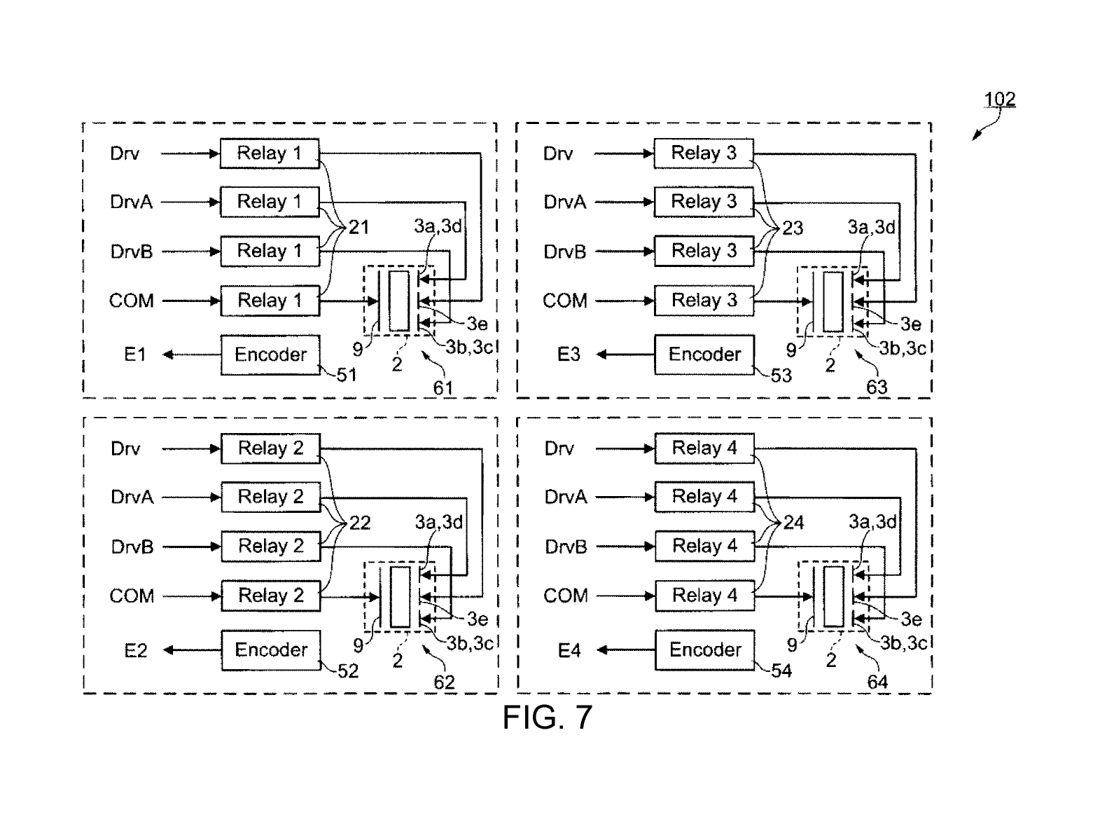

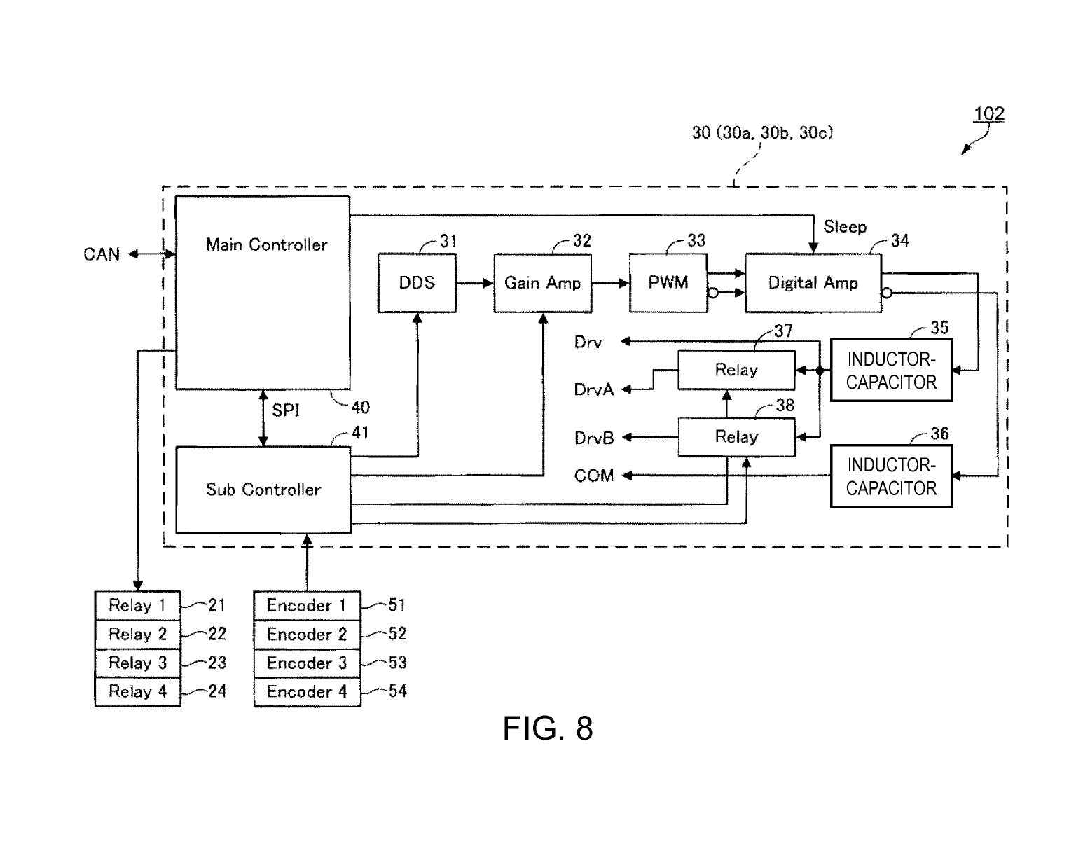

FIG. 6 is a schematic view showing the configuration of a piezoelectric motor used in the drive device according to the second embodiment. FIG. 7 is a block diagram showing the configuration of the drive device according to the second embodiment. FIG. 8 is a block diagram showing the configuration of a drive circuit according to the second embodiment.

A drive device 102 according to the second embodiment has three drive units (not shown), similarly to the drive device 100 according to the first embodiment. Each drive unit has a drive circuit 30, piezoelectric motors 61, 62, 63, 64, and relays 21, 22, 23, 24. As shown in FIG. 6, each of the piezoelectric motors 61, 62, 63, 64 has an oscillating body 2, a driven member 5, a holding member 8, an urging spring 6, and a base 7.

The surface of an electrode 3 of the oscillating body 2 is divided into five parts. That is, an electrode portion 3e is provided in addition to electrode portions 3a, 3b, 3c, 3d. The electrode portion 3e is arranged in a central section in the lateral direction between the electrode portions 3a, 3b and the electrode portions 3c, 3d and has substantially the same area as the area of the electrode portions 3a, 3d combined (the area of the electrodes 3c, 3b combined). The electrode portion 3e functions as a longitudinal oscillation electrode. Longitudinal oscillation refers to oscillation in an expanding and contracting manner along the longitudinal direction of the oscillating body 2.

As shown in FIG. 7, the piezoelectric motors 61, 62, 63, 64 are electrically connected to or cut off from the drive circuit 30 by the relays 21, 22, 23, 24, respectively. The piezoelectric motor electrically connected to the drive circuit 30 is supplied with either a first bending oscillation signal (DrvA) or a second bending oscillation signal (DrvB), and a longitudinal oscillation drive signal (Drv).

When the first bending oscillation drive signal (DrvA) is supplied to the electrode portions 3a, 3d of the oscillating body 2 and the longitudinal oscillation drive signal (Dry) is supplied to the electrode portion 3e, bending oscillation to bend along the lateral direction of the oscillating body 2 and longitudinal oscillation to expand and contract along the longitudinal direction are excited. As these bending oscillation and longitudinal oscillation are combined to excite oscillation in the oscillating body 2, a sliding portion 4 slides, following a clockwise elliptical trajectory. This causes the driven member 5 to rotate counterclockwise.

When the second bending oscillation drive signal (DrvB) is supplied to the electrode portions 3c, 3b of the oscillating body 2 and the longitudinal oscillation drive signal (Dry) is supplied to the electrode portion 3e, bending oscillation and longitudinal oscillation are combined to excite oscillation in the oscillating body 2. Thus, the sliding portion 4 slides, following a counterclockwise elliptical trajectory. This causes the driven member 5 to rotate clockwise.

As shown in FIG. 8, the drive circuit 30 of the drive device 102 according to the second embodiment has the same configuration as in the first embodiment except that the longitudinal oscillation drive signal (Dry) is outputted. The longitudinal oscillation drive signal (Dry) is outputted from an inductor-capacitor 35, irrespective of the operation of relays 37, 38.

In this manner, the drive device 102 according to the second embodiment has the piezoelectric motors 61, 62, 63, 64, in each of which the electrode of the oscillating body 2 is divided into five parts, that is, the longitudinal oscillation electrode portion 3e in addition to the bending oscillation electrode portions 3a, 3b, 3c, 3d. However, as in the first embodiment, the piezoelectric motors 61, 62, 63, 64 selectively electrically connected to the drive circuit 30 by the relays 21, 22, 23, 24. Therefore, the drive device 102 according to the second embodiment has similar effects to those of the drive device 100 according to the first embodiment.

### Third Embodiment

### Electronic Component Carrying Device and Electronic Component Inspection Device

Next, an electronic component carrying device and an electronic component inspection device according to a third embodiment will be described. The electronic component carrying device and the electronic component inspection device according to the third embodiment include a positioning mechanism having a similar configuration to the basic configuration of the drive device according to the first embodiment. Hereinafter, this embodiment is described mainly in terms of the difference from each of the foregoing embodiments, and explanation of similar elements is omitted.

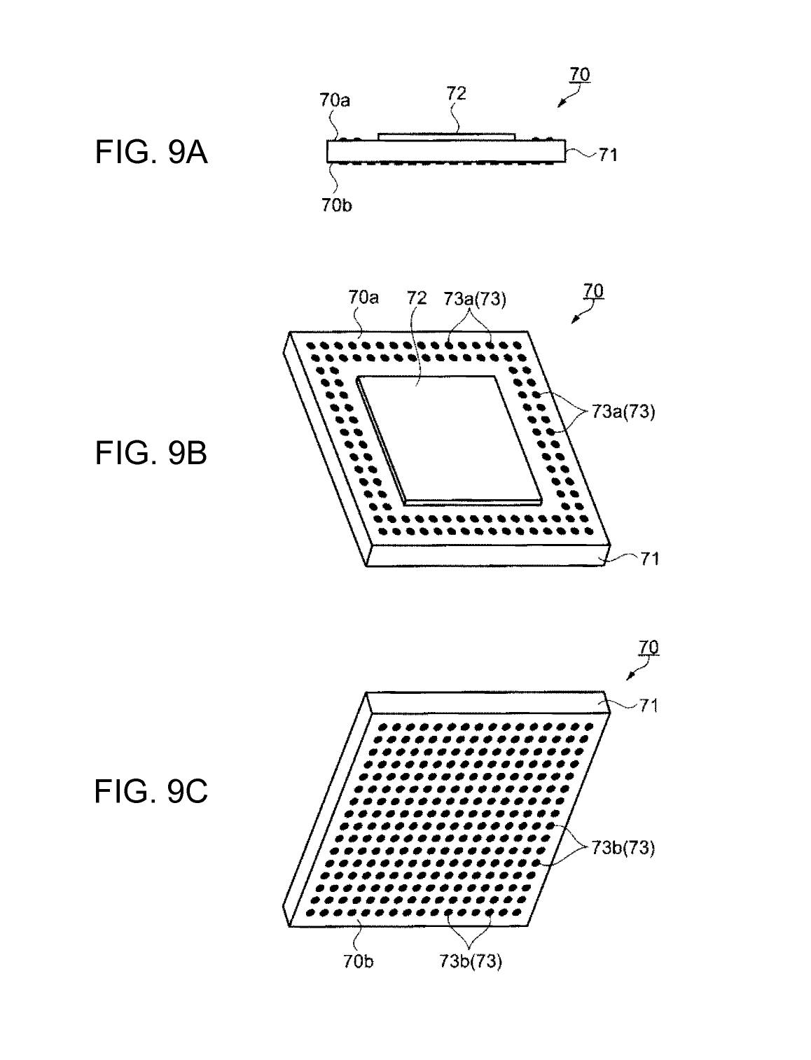

First, an example of an electronic component carried or inspected by the electronic component carrying device and the electronic component inspection device according to the third embodiment will be described. FIGS. 9A to 9C show an example of an electronic component according to the third embodiment. Specifically, FIG. 9A is a schematic side view showing the structure of the electronic component. FIGS. 9B and 9C are schematic perspective views showing the structure of the electronic component. FIG. 9B shows the surface where a semiconductor element is formed. FIG. 9C shows the surface where only electrodes are formed.

As shown in FIGS. 9A, 9B and 9C, an electronic component 70 has a quadrilateral substrate 71. One surface of the substrate 71 is referred to as a first surface 70a, and the other surface is referred to as a second surface 70b. As shown in FIG. 9B, a quadrilateral semiconductor chip 72 is installed on the first surface 70a, and first electrodes 73a arrayed in two lines are arranged around the semiconductor chip 72. As shown in FIG. 9C, second electrodes 73b are arranged in a lattice form on the second surface 70b. Inside the substrate 71, a wiring layer and an insulating layer are stacked on each other. The semiconductor chip 72 is connected to the electrodes 73 including the first electrodes 73a and the second electrodes 73b via the wire in the wiring layer.

It should be noted that while the electronic component 70 having the semiconductor chip 72 mounted on the substrate 71 is described here as an example of an electronic component, the electronic component is not limited to this configuration. The electronic component may be, for example, a semiconductor chip, a display device such as LCD, a crystal device, various sensors, an inkjet head and the like.

Next, the electronic component carrying device and the electronic component inspection device according to the third embodiment will be described.

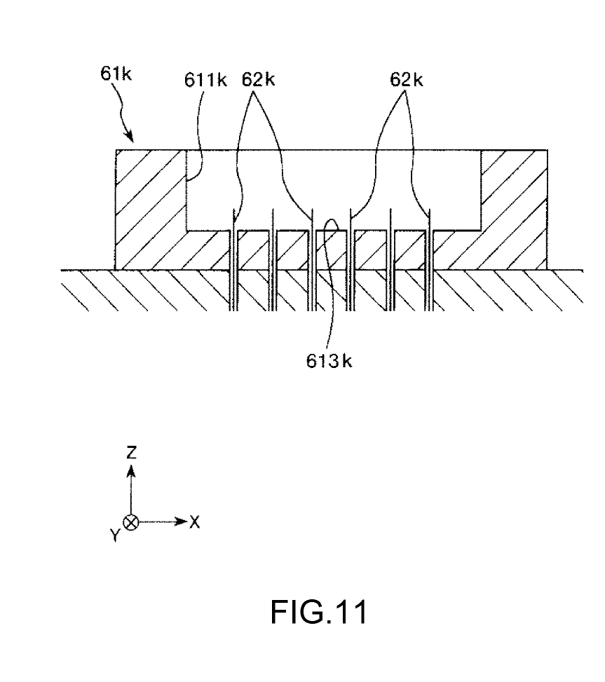

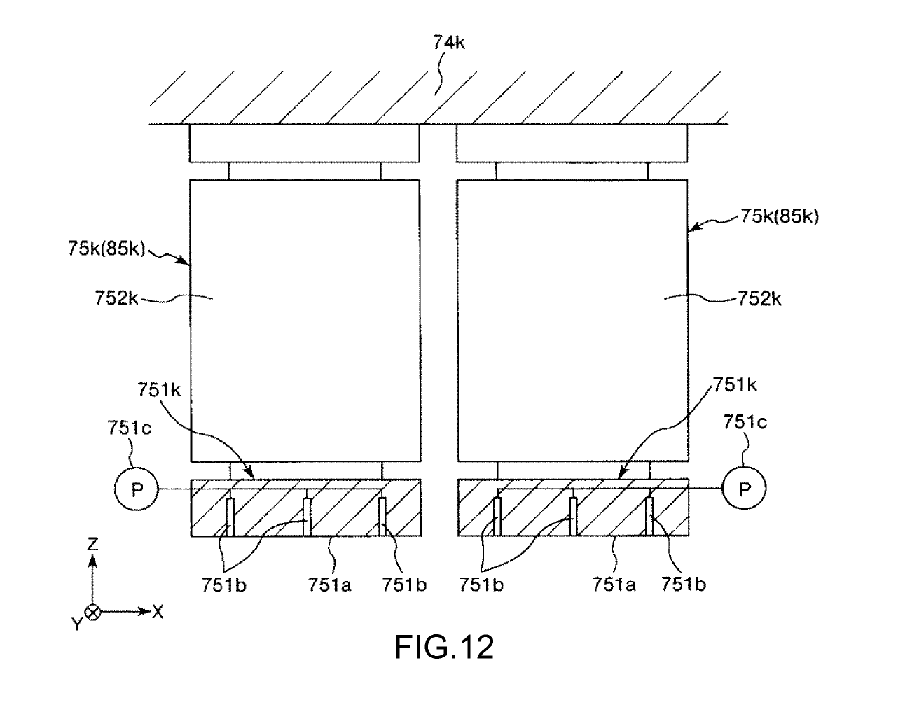

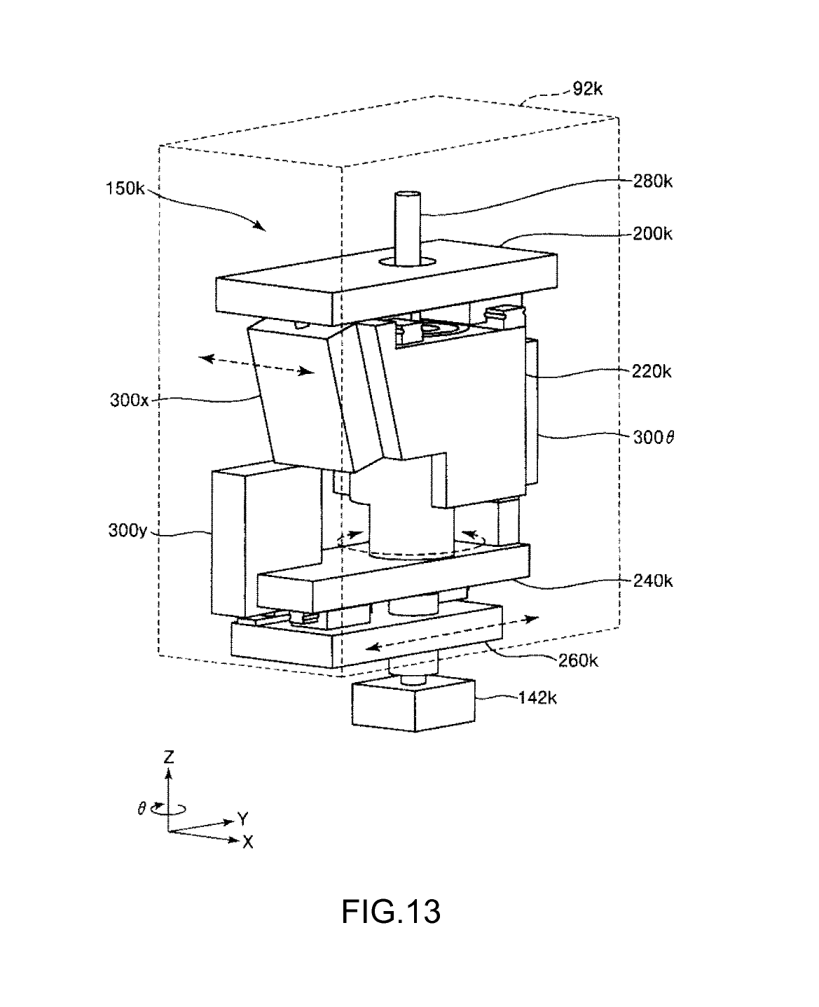

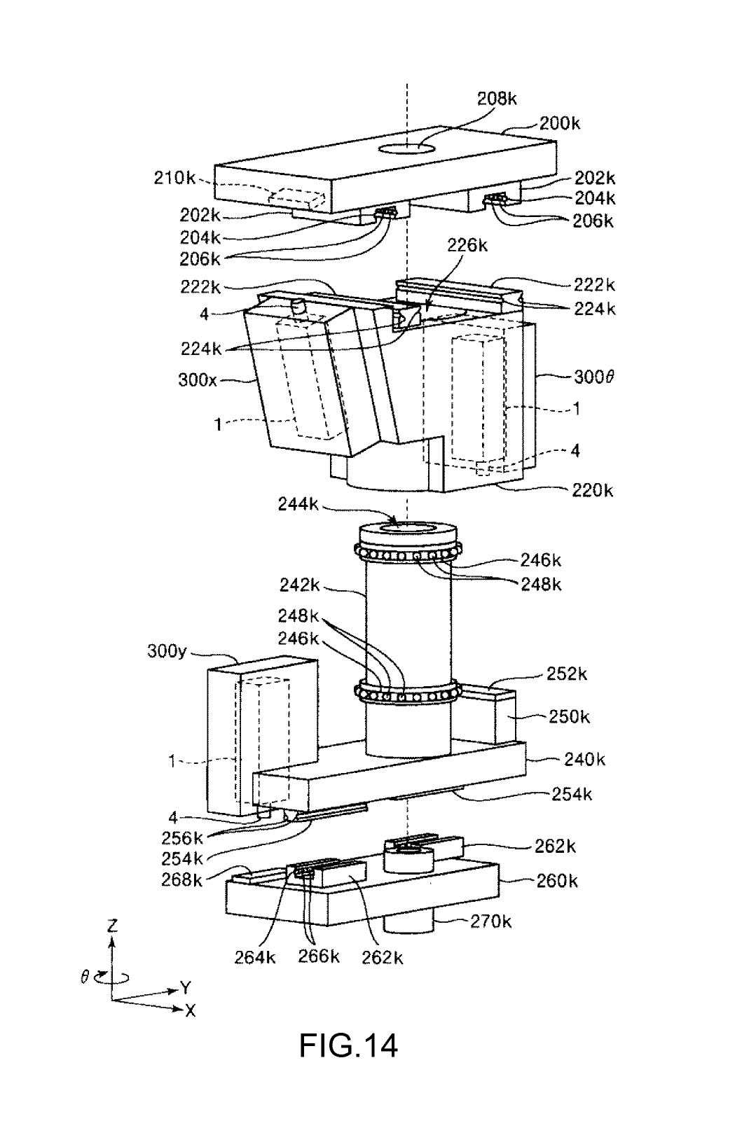

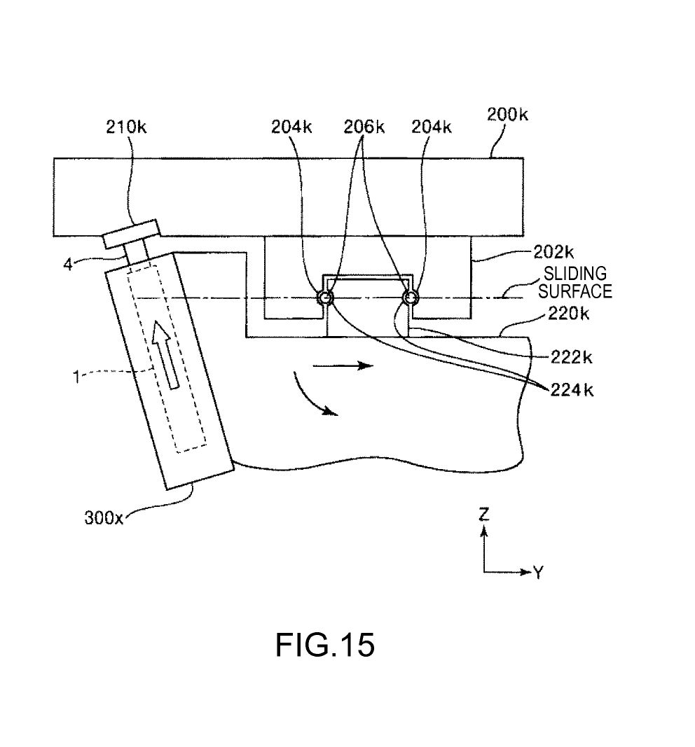

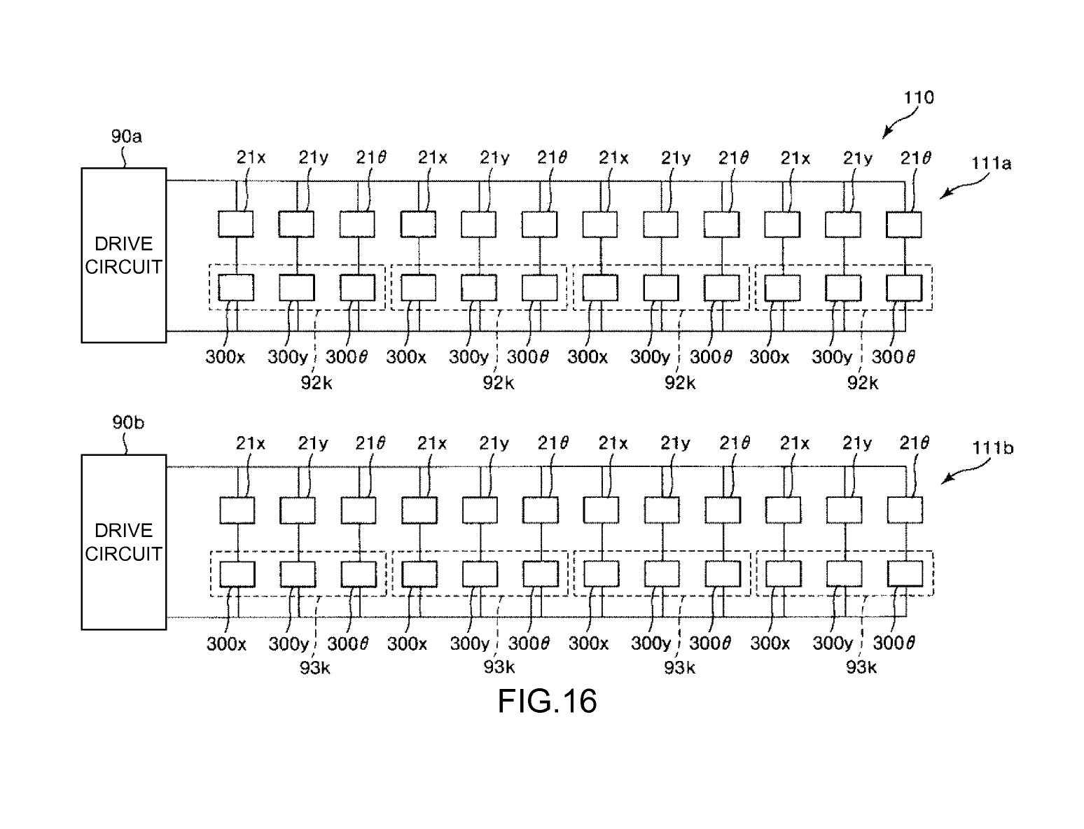

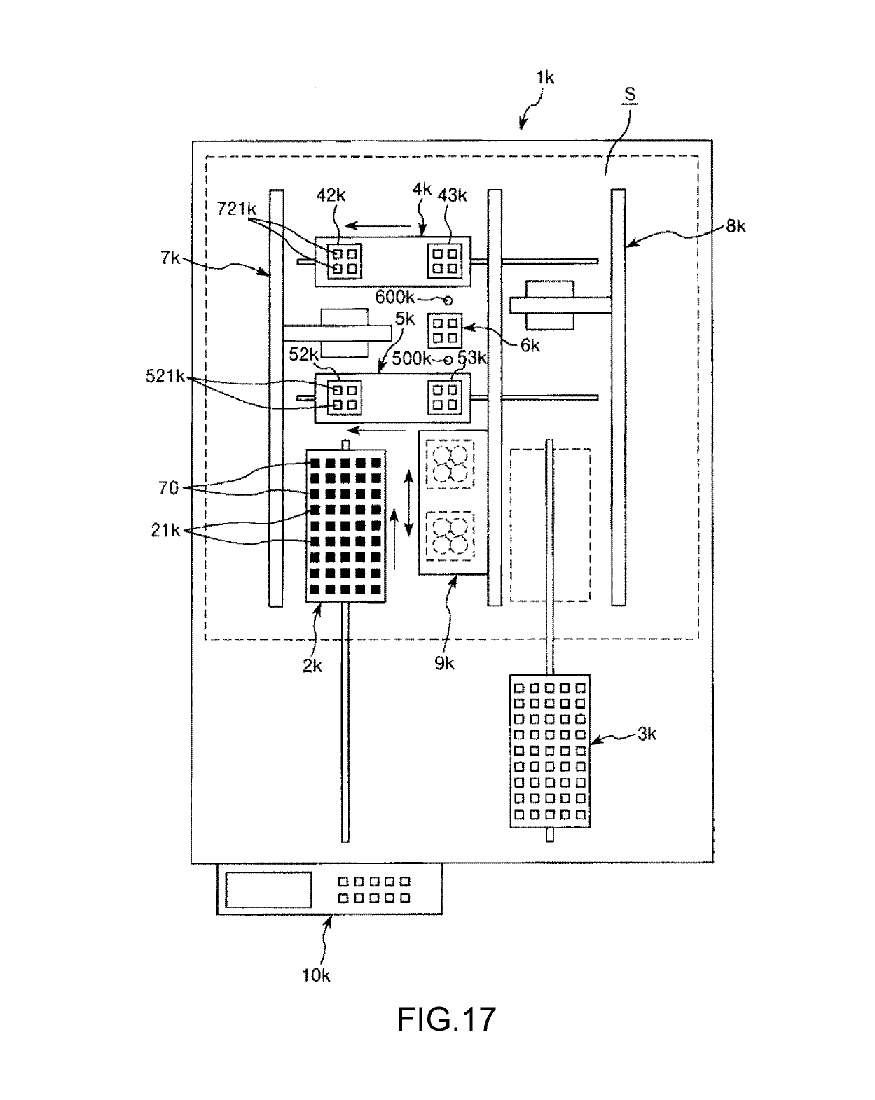

FIG. 10 is a schematic plan view showing the electronic component carrying device and the electronic component inspection device according to the third embodiment. FIG. 11 is a cross-sectional view of an inspection individual socket for inspection provided in the electronic component inspection device shown in FIG. 10. FIG. 12 is a partial cross-sectional view showing a hand unit of a supply robot provided in the electronic component inspection device shown in FIG. 10. FIG. 13 is a perspective view showing a hand unit of an inspection robot provided in the electronic component inspection device shown in FIG. 10. FIG. 14 is an exploded perspective view showing the hand unit of the inspection robot provided in the electronic component inspection device shown in FIG. 10. FIG. 15 is a view showing a moving mechanism of the hand unit of the inspection robot provided in the electronic component inspection device shown in FIG. 10, as taken along a plane perpendicular to the X-direction. FIG. 16 is a block diagram showing the schematic configuration of a positioning mechanism provided in the electronic component inspection device shown in FIG. 10. FIGS. 17 to 25 are plan views illustrating inspection procedures for an electronic component by the electronic component inspection device shown in FIG. 10.

In FIG. 15, the vicinity of a part where a piezoelectric motor 300x is attached to an X block 220k is enlarged.

### Electronic Component Inspection Device

An electronic component inspection device 1k shown in FIG. 10 is a device for inspecting electrical characteristics of the electronic component 70.

The electronic component inspection device 1k has a supply tray 2k, a collection tray 3k, a first shuttle 4k, a second shuttle 5k, an inspection socket (inspection portion) 6, a supply robot 7k, a collection robot 8k, an inspection robot 9k, a controller 10k for controlling each component, a positioning mechanism 110, a first camera 600k, and a second camera 500k.

In the electronic component inspection device 1k of this embodiment, the configuration excluding the inspection socket 6k, that is, the supply tray 2k, the collection tray 3k, the first shuttle 4k, the second shuttle 5k, the supply robot 7k, the collection robot 8k, the inspection robot 9k, the controller 10k, the positioning mechanism 110, the first camera 600k and the second camera 500k form an electronic component carrying device that executes carrying operation of the electronic component 70.

The electronic component inspection device 1k also has a pedestal 11k for installing each of the above components thereon, and a safety cover, not shown, that is laid over the pedestal 11k to accommodate each of the components. On the inner side of this safety cover (hereinafter referred to as an “area S”), the first shuttle 4k, the second shuttle 5k, the inspection socket 6k, the supply robot 7k, the collection robot 8k, the inspection robot 9k, the first camera 600k and the second camera 500k are arranged. The supply tray 2k and the collection tray 3k are arranged to be movable in and out of the area S. In the area S, inspection of electrical characteristics of the electronic component 70 is carried out.

### Supply Tray

The supply tray 2k is a tray for carrying the electronic component 70 to be inspected, from the outside of the area S into the area S. As shown in FIG. 10, the supply tray 2k is plate-shaped and plural (multiple) pockets 21k to hold the electronic component 70 are formed in a matrix form on an upper surface of the supply tray 2k.

Such a supply tray 2k is supported on a rail 23k extending in the Y-direction over the inside and outside of the area S and is movable in a reciprocating manner in the Y-direction along the rail 23k by a drive unit, not shown, for example, by a linear motor or the like. Therefore, after the electronic component 70 is arranged on the supply tray 2k outside the area S, the supply tray 2k can be moved into the area S. Then, after all the electronic components 70 are removed from the supply tray 2k, the supply tray 2k in the area S can be moved out of the area S.

The supply tray 2k need not be supported directly on the rail 23k. For example, a stage having a placement surface may be supported on the rail 23k, and the supply tray 2k may be placed on the placement surface of the stage. According to such a configuration, accommodation of the electronic component 70 onto the supply tray 2k can be carried out in another place than the electronic component inspection device 1k, and this improves convenience of the device. Also, the collection tray 3k, described later, can be configured similarly.

### Collection Tray

The collection tray 3k is a tray for accommodating the electronic component 70 that is already inspected, and carrying the electronic component 70 from the inside of the area S to the outside of the area S. As shown in FIG. 10, the collection tray 3k is plate-shaped and plural pockets 31k to hold the electronic component 70 are formed in a matrix form on an upper surface of the collection tray 3k.

Such a collection tray 3k is supported on a rail 33k extending in the Y-direction over the inside and outside of the area S and is movable in a reciprocating manner in the Y-direction along the rail 33k by a drive unit, not shown, for example, by a linear motor or the like. Therefore, after the inspected electronic component 70 is arranged on the collection tray 3k inside the area S, the supply tray can be moved into the area S. Then, after all the electronic components 70 are removed from the supply tray 2k, the collection tray 3k can be moved out of the area S.

Similarly to the supply tray 2k, the collection tray 3k need not be supported directly on the rail 33k. For example, a stage having a placement surface may be supported on the rail 33k, and the collection tray 3k may be placed on the placement surface of the stage.

Such a collection tray 3k is spaced apart from the supply tray 2k in the X-direction. The first shuttle 4k, the second shuttle 5k and the inspection socket 6k are arranged between the supply tray 2k and the collection tray 3k.

### First Shuttle

The first shuttle 4k is for carrying the electronic component 70 carried into the area S by the supply tray 2k, further to the vicinity of the inspection socket 6k, and for carrying the inspected electronic component 70 inspected in the inspection socket 6k, to the vicinity of the collection tray 3k.

As shown in FIG. 10, the first shuttle 4k has a base member 41k, and two trays 42k, 43k secured to the base member 41k. These two trays 42k, 43k are aligned in the X-direction. On an upper surface of each of the trays 42k, 43k, four pockets 421k, 431k to hold the electronic component 70 are formed in a matrix form. Specifically, on the trays 42k, 43k, the four pockets 421k, 431k are formed, with two pockets each aligned in the X-direction and in the Y-direction.

Of the trays 42k, 43k, the tray 42k situated on the side of the supply tray 2k is a tray for accommodating the electronic component 70 accommodated on the supply tray 2k, whereas the tray 43k situated on the side of the collection tray 3k is a tray for accommodating the electronic component 70 on which inspection of electrical characteristics in the inspection socket 6k is finished. That is, one tray 42k is a tray for accommodating the electronic component 70 yet to be inspected, and the other tray 43k is a tray for accommodating the electronic component 70 that is already inspected.

The electronic component 70 accommodated on the tray 42k is carried to the inspection socket 6k by the inspection robot 9k. The electronic component 70 arranged in the inspection socket 6k for inspection is carried to the tray 43k by the inspection robot 9k after the inspection is finished.

Such a first shuttle 4k is supported on a rail 44k extending in the X-direction and is movable in a reciprocating manner in the X-direction along the rail 44k by a drive unit, not shown, for example, by a linear motor or the like. Thus, a state where the first shuttle 4k is moved to the (−) side in the X-direction and the tray 42k is aligned with the supply tray 2k on the (+) side in the Y-direction while the tray 43k is aligned with the inspection socket 6k on the (+) side in the Y-direction, and a state where the first shuttle 4k is moved to the (+) side in the X-direction and the tray 43k is aligned with the collection tray 3k on the (+) side in the Y-direction while the tray 42k is aligned with the inspection socket 6k on the (+) side in the Y-direction, can be employed.

### Second Shuttle

The second shuttle 5k has a similar function and configuration to the first shuttle 4k. That is, the second shuttle 5k is for carrying the electronic component 70 carried into the area S by the supply tray 2k, further to the vicinity of the inspection socket 6k, and for carrying the inspected electronic component 70 inspected in the inspection socket 6k, to the vicinity of the collection tray 3k.

As shown in FIG. 10, the second shuttle 5k has a base member 51k, and two trays 52k, 53k secured to the base member 51k. These two trays 52k, 53k are aligned in the X-direction. On an upper surface of each of the trays 52k, 53k, four pockets 521k, 531k to hold the electronic component 70 are formed in a matrix form.

Of the trays 52k, 53k, the tray 52k situated on the side of the supply tray 2k is a tray for accommodating the electronic component 70 accommodated on the supply tray 2k, whereas the tray 53k situated on the side of the collection tray 3k is a tray for accommodating the electronic component 70 on which inspection of electrical characteristics in the inspection socket 6k is finished.

The electronic component 70 accommodated on the tray 52k is carried to the inspection socket 6k by the inspection robot 9k. The electronic component 70 arranged in the inspection socket 6k for inspection is carried to the tray 53k by the inspection robot 9k after the inspection is finished.

Such a second shuttle 5k is supported on a rail 54k extending in the X-direction and is movable in a reciprocating manner in the X-direction along the rail 54k by a drive unit, not shown, for example, by a linear motor or the like. Thus, a state where the second shuttle 5k is moved to the (−) side in the X-direction and the tray 52k is aligned with the supply tray 2k on the (+) side in the Y-direction while the tray 53k is aligned with the inspection socket 6k on the (−) side in the Y-direction, and a state where the second shuttle 5k is moved to the (+) side in the X-direction and the tray 53k is aligned with the collection tray 3k on the (+) side in the Y-direction while the tray 52k is aligned with the inspection socket 6k on the (−) side in the Y-direction, can be employed.

The second shuttle 5k is spaced apart from the first shuttle 4k in the Y-direction. The inspection socket 6k is arranged between the first shuttle 4k and the second shuttle 5k.

### Inspection Socket

The inspection socket (inspection portion) 6 is a socket for inspecting electrical characteristics of the electronic component 70.

The inspection socket 6k includes four inspection sockets 61k to arrange the electronic component 70 therein. The four inspection sockets 61k are provided in a matrix form. Specifically, the four inspection sockets 61k are provided with two inspection sockets each arrayed in the X-direction and in the Y-direction. It should be noted that the number of the inspection sockets 61k is not limited to four and may be one to three or may be five or more. The way the inspection sockets 61k are arrayed is not particularly limited, either. The inspection sockets 61k may be arranged, for example, in one line in the X-direction or in the Y-direction.

In view of improved efficiency of operation, the larger the number of the inspection sockets 61k, the better. However, in further consideration of a reduction in the size of the electronic component inspection device 1k, it is preferable that the number of the inspection sockets 61k is approximately four to twenty. Thus, the number of the electronic components 70 that can be inspected in one round of inspection is sufficiently large, enabling improved efficiency of operation. The plural inspection sockets 61k may be arrayed in a matrix form or in one line. That is, the inspection sockets 61k may be arranged in a matrix form such as 2×2, 4×4 or 8×2, or may be arranged in one line such as 4×1 or 8×1.

It is also preferable that the pockets 421k formed on the tray 42k (the same applies to the trays 43k, 52k, 53k) are arranged similarly to the inspection sockets 61k, with substantially equal arrangement pitches. Thus, the electronic component 70 accommodated on the tray 42k, 52k can be smoothly relocated into the inspection socket 61k. Also, the electronic component 70 arranged in the inspection socket 61k can be smoothly relocated onto the tray 43k, 53k. This enables improved efficiency of operation.

As shown in FIG. 11, each inspection socket 61k has a lateral surface 611k perpendicular to the XY plane. Here, a traditional inspection individual socket has a tapered lateral surface to facilitate arrangement of the electronic component 70 in the inspection individual socket. The reason for having to taper the lateral surface is that the electronic component 70 cannot be positioned in the inspection individual socket with high accuracy. According to the technique of the invention, the electronic component 70 can be positioned in the inspection socket 61k with higher accuracy than in the traditional device and therefore the lateral surface need not be tapered. As the lateral surface is formed as a surface perpendicular to the XY plane, the electronic component 70 can be held in the inspection socket 61k more securely than in the traditional socket with the tapered lateral surface. That is, unintended displacement of the electronic component 70 in the inspection socket 61k can be prevented securely.

Each inspection socket 61k is also provided with plural probe pins 62k protruding from a bottom part 613k. Each of the plural probe pins 62k is urged upward by a spring or the like, not shown. The probe pins 62k contact the external terminal of the electronic component 70 when the electronic component 70 is arranged in the inspection socket 61k. This creates a state where the electronic component 70 and an inspection control unit 101k are electrically connected to each other via the probe pins 62k, that is, a state where inspection of electrical characteristics of the electronic component 70 can be carried out.

Moreover, a camera, not shown, is provided near the inspection socket 6k. Also, a socket mark, not shown, is provided near the inspection socket 61k. Thus, as the camera recognizes the relative position of the inspection socket 61k and the socket mark, then recognizes the relative position of the socket mark and a device mark provided on a first hand unit 92k, described later, and recognizes the relative position of the device mark and the electronic component 70, the inspection socket 61k and the electronic component 70 can be positioned with each other accurately.

### First Camera

As shown in FIG. 10, the first camera 600k is provided between the first shuttle 4k and the inspection socket 6k and aligned with the inspection socket 6k on the (+) side in the Y-direction. Such a first camera 600k picks up an image of the electronic component 70 held on the first hand unit 92k and the device mark provided on the first hand unit 92k, when the first hand unit 92k of the inspection robot 9k holding the electronic component 70 that is previously accommodated on the tray 42k passes above the first camera 600k.

### Second Camera

As shown in FIG. 10, the second camera 500k has a similar function to the first camera 600k. Such a second camera 500k is provided between the second shuttle 5k and the inspection socket 6k and aligned with the inspection socket 6k on the (−) side in the Y-direction. The second camera 500k picks up an image of the electronic component 70 held on the second hand unit 93k and a device mark provided on the second hand unit 93k, when the second hand unit 93k of the inspection robot 9k holding the electronic component 70 that is previously accommodated on the tray 52k passes above the second camera 500k.

### Supply Robot

The supply robot 7k is a robot for relocating the electronic component 70 accommodated on the supply tray 2k carried in the area S, onto the tray 42k of the first shutter 4k and the tray 52k of the second shuttle 5k.

As shown in FIGS. 10 and 12, the supply robot 7 has a support frame 72k supported on the pedestal 11k, a moving frame (Y-direction moving frame) 73k supported on the support frame 72k and movable in a reciprocating manner in the Y-direction relative to the support frame 72k, a hand unit support portion (X-direction moving frame) 74k supported on the moving frame 73k and movable in a reciprocating manner in the X-direction relative to the moving frame 73k, and four hand units 75k supported on the hand unit support portion 74k.

A rail 721k extending in the Y-direction is formed on the support frame 72k, and along this rail 721k, the moving frame 73k reciprocates in the Y-direction. Also, a rail, not shown, extending in the X-direction is formed on the moving frame 73k, and along this rail, the hand unit support portion 74k reciprocates in the X-direction.

The movement of the moving frame 73k relative to the support frame 72k and the movement of the hand unit support portion 74k relative to the moving frame 73k can be carried out respectively, for example, by a drive unit such as a linear motor.

The four hand units 75k are arranged in a matrix form so that two hand units each are arrayed in the X-direction and in the Y-direction. As the hand units 75k are thus provided to correspond to the arrangement of the four pockets 421k, 521k formed on the trays 42k, 52k, the electronic component 70 can be smoothly relocated from the supply tray 2k to the trays 42k, 52k. The number of the hand units 75k is not limited to four and may be, for example, one to three, or may be five or more. The hand units 75k may be structured to vary in the arrangement thereof according to the arrangement of the pockets 21k and the arrangement of the pockets 421k, 521k.

As shown in FIG. 12, each hand unit 75k has a holding portion 751k that is situated at the distal end side and holds the electronic component 70, and a lift device 752k that reciprocates (raises and lowers) the holding portion 751k in the Z-direction relative to the hand unit support portion 74k. The lift device 752k can be, for example, a device utilizing a drive unit such as a linear motor.

The holding portion 751k has a suction surface 751a facing the electronic component 70, a suction hole 751b opened in the suction surface 751a, and a pressure reducing pump 751c that reduces pressure in the suction hole 751b. If pressure in the suction hole 751b is reduced by the pressure reducing pump 751c in the state where the electronic component 70 contacts the suction surface 751a in the way of closing the suction hole 751b, the electronic component 70 can be sucked to and held on the suction surface 751a. In contrast, if the pressure reducing pump 751c is stopped to relieve the suction hole 751b, the electronic component 70 that is held thereon can be detached.

Such a supply robot 7k carries the electronic component 70 from the supply tray 2k to the trays 42k, 52k in the following manner. Since the electronic component 70 is carried from the supply tray 2k to each of the trays 42k, 52k in similar manners, the carrying of the electronic component to the tray 42k will be described hereinafter as a representative example.

First, the shuttle 4k is moved to the (−) side in the X-direction so that the tray 42k is aligned with the supply tray 2k in the Y-direction. Next, the moving frame 73k is moved in the Y-direction so that the hand units 75k are situated over the supply tray 2k, while the hand unit support portion 74k is moved in the X-direction. Next, the holding portion 751k is lowered by the lift device 752k and the holding portion 751k is made to contact the electronic component 70 on the supply tray 2k. Thus, the holding portion 751k is made to hold the electronic component 70 by the foregoing method.

Next, the holding portion 751k is raised by the lift device 752k and the electronic component 70 held on the supply tray 2k is removed from the supply tray 2k. Next, the moving frame 73k is moved in the Y-direction so that the hand units 75k are situated over the tray 42k of the first shuttle 4k, while the hand unit support portion 74k is moved in the X-direction. Next, the holding portion 751k is lowered by the lift device 752k and the electronic component 70 held by the holding portion 751k is arranged in the pocket 421k of the tray 42k. Next, the suction state of the electronic component 70 is canceled and the electronic component 70 is detached from the holding portion 751k. Such operation may be repeated according to need.

The carrying (relocation) of the electronic component 70 from the supply tray 2k to the tray 42k is thus completed.

### Inspection Robot

The inspection robot 9k is a device that carries the electronic component 70 carried to the tray 42k, 52k by the supply robot 7k, further into the inspection socket 6k, and also carries the electronic component 70 which is arranged in the inspection socket 6k and finished with inspection of electrical characteristics thereof, to the tray 43k, 53k.

The inspection robot 9k can also position the electronic component 70 in the inspection socket 6k (inspection socket 61k) with high accuracy when carrying the electronic component 70 from the tray 42k, 52k into the inspection socket 6k.

The inspection robot 9k also has the function of pressing the electronic component 70 against the probe pins 62k and thus applying a predetermined inspection pressure to the electronic component 70 when arranging the electronic component 70 in the inspection socket 6k and carrying out inspection of electrical characteristics.

As shown in FIG. 10, the inspection robot 9k has a first frame 911k provided in a fixed manner on the pedestal 11k, a second frame 912k supported on the first frame 911k and movable in a reciprocating manner in the Y-direction relative to the first frame 911k, a first hand unit support portion 913k and a second hand unit support portion 914k supported on the second frame 912k, four first hand units 92k supported on the first hand unit support portion 913k, and four second hand units 93k supported on the second hand unit support portion 914k.

A rail 911ak extending in the Y-direction is formed on the first frame 911k, and along this rail 911ak, the second frame 912k reciprocates in the Y-direction. Through-holes 912ak, 912bk extending in the Z-direction are formed in the second frame 912k.

The movement of the second frame 912k relative to the first frame 911k can be carried out, for example, by a drive unit, not shown, such as a linear motor.

The four first hand units 92k supported on the first hand unit support portion 913k are a device that carries the electronic component 70 between each tray 42k, 43k of the first shuttle 4k and the inspection socket 6k. The first hand units 92k are also a device that positions the electronic component 70 in the inspection socket 6k (inspection socket 61k) when carrying the electronic component 70 that is yet to be inspected, from the tray 42k into the inspection socket 6k.

Similarly, the four second hand units 93k supported on the second hand unit support portion 914k are a device that carries the electronic component 70 between each tray 52k, 53k of the second shuttle 5k and the inspection socket 6k. The second hand units 93k are also a device that positions the electronic component 70 in the inspection socket 6k (inspection socket 61k) when carrying the electronic component 70 that is yet to be inspected, from the tray 52k into the inspection socket 6k.

The four first hand units 92k are arranged in a matrix form, with two first hand units each arrayed in the X-direction and in the Y-direction, on the lower side of the first hand unit support portion 913k. The arrangement pitch of the four first hand units 92k is substantially equal to the arrangement pitch of the four pockets 421k formed on the tray 42k (the same applies to the trays 43k, 52k, 53k) and of the four inspection sockets 61k provided in the inspection socket 6k.

As the first hand units 92k are thus arranged to correspond to the arrangement of the pockets 421k and the inspection sockets 61k, the electronic component 70 can be smoothly carried between the trays 42k, 43k and the inspection socket 6k.

The number of the first hand units 92k is not limited to four and may be, for example, one to three, or may be five or more.

Similarly, the four second hand units 93k are arranged in a matrix form, with two second hand units each arrayed in the X-direction and in the Y-direction, on the lower side of the second hand unit support portion 914k. The arrangement and arrangement pitch of these four second hand units 93k are similar to those of the four first hand units 92k.

Hereinafter, the configuration of the first hand units 92k and the second hand units 93k will be described in detail with reference to FIGS. 13 to 15. Since the respective hand units 92k, 93k have similar configurations, one firsthand unit 92k will be described hereinafter as a representative example. Description of the other first hand units 92k and the respective second hand units 93k is omitted.

As shown in FIGS. 13 and 14, the first hand unit 92k has a moving mechanism 150k for fine-tuning the coordinates in the X-direction and Y-direction and the rotation angle in the θ-direction, which is a direction of rotation (pivoting) about the Z-direction as a rotation axis (pivot), and a Z-stage movable in the Z-direction. At a distal end portion of the first hand unit 92k, a grip portion 142k to grip the electronic component 70 is provided. The configuration of the grip portion 142k is similar to that of the holding portion 751k of the hand unit 75k, and a pressure reducing pump and the like are not shown in FIG. 13.

In the moving mechanism 150k, a unit base (base portion) 200k supporting the entire body is arranged at the top stage. The unit base 200k is mounted on the first hand unit support portion 913k. Below the unit base 200k, an X-block 220k is provided to be movable in the X-direction relative to the unit base 200k. Below the X-block 220k, a θ-block 240k that follows the movement of the X-block 220k and is rotatable in the θ-direction is provided. Moreover, below the θ-block 240k, a Y-block 260k that follows the movement of the θ-block 240k and is movable in the Y-direction relative to the θ-block 240k is provided. The θ-block 240k is arranged between the X-block 220k and the Y-block 260k. Dashed lines with arrows in FIG. 13 indicate the moving directions of the respective blocks (220k, 240k, 260k). The X-block 220k, the Y-block 260k and the θ-block 240k in this embodiment are equivalent to the “moving portions” according to the invention. That is, the X-block 220k is equivalent to the “first moving portion”. The Y-block 260k is equivalent to the “second moving portion”. The θ-block 240k is equivalent to the “third moving portion”.

In the moving mechanism 150k, three piezoelectric motors, that is, an X-direction piezoelectric motor 300x to drive the X-block 220k, a θ-direction piezoelectric motor 300θ to drive the θ-block 240k, and a Y-direction piezoelectric motor 300y to drive the Y-block 260k are provided. In the case where the three piezoelectric motors (300x, 300θ, 300y) need not be particularly discriminated from one another, these piezoelectric motors may be referred to simply as a piezoelectric motor(s) 300k. As the piezoelectric motor(s) 300k, a piezoelectric motor similar to the one in each of the foregoing embodiments is used.

Moreover, in the moving mechanism 150k, a shaft 280k penetrating the unit base 200k, the X-block 220k, the θ-block 240k and the Y-block 260k in up and down direction (Z-direction) is provided. The shaft 280k is mounted to be movable in the Z-direction relative to the Y-block 260k. The shaft 280k follows the movement of the Y-block 260k and moves in the Z-direction by an operation of the Z-stage, not shown. The Z-stage can be moved, for example, by a linear motor or the like. The grip portion 142k is mounted at a lower end of the shaft 280k.

The unit base 200k is in the form of a substantially rectangular flat plate, in which a through-hole 208k with a circular cross section for the shaft 280k to be inserted therein is provided. The size of the through-hole 208k is formed in such a way that the shaft 280k does not abut against the inner peripheral surface thereof even when the shaft 280k follows the movement of the Y-block 260k and moves in the X-direction and Y-direction. On the lower surface of the unit base 200k (the surface facing the X-block 220k), two X-rail props 202k formed with a downward concave cross section are provided extending parallel to the X-direction. These two X-rail props 202k are spaced apart from each other in the Y-direction. On inner lateral surfaces of the X-rail props 202k, outer grooves 204k with a semicircular cross section are formed. Plural balls 206k are arranged along the outer grooves 204k.

On an upper surface of the X-block 220k (the surface facing the unit base 200k), two X-rails 222k corresponding to the two X-rail props 202k on the side of the unit base 200k are provided extending parallel to the X-direction. On both lateral surfaces of the X-rails 222k, inner grooves 224k facing the outer grooves 204k of the X-rail props 202k are formed. In the state where the X-rails 222k are fitted with the corresponding X-rail props 202k, the balls 206k are inserted between the inner grooves 224k and the outer grooves 204k, thus forming ball guides on both sides of each X-rail 222k. As the balls 206k roll along the inner grooves 224k and the outer grooves 204k, the X-block 220k smoothly moves relative to the unit base 200k.

On one of the lateral surfaces facing the Y-direction of the X-block 220k (on the forward side in FIG. 13), the piezoelectric motor 300x is mounted. The piezoelectric motor 300θ is mounted on the other surface (on the rear side in FIG. 13). The piezoelectric motor 300x to drive the X-block 220k is mounted in the state where the lateral direction of the oscillating body 1 is aligned with the X-direction and where the sliding portion 4 of the oscillating body 1 is urged to the unit base 200k. In the portion on the side of the unit base 200k to which the sliding portion 4 is urged, a ceramic pressure receiver 210k substantially in the form of a rectangular parallelepiped is embedded. The piezoelectric motor 300θ to drive the θ-block 240k is mounted in the state where the lateral direction of the oscillating body 1 is aligned with the X-direction and where the sliding portion 4 of the oscillating body 1 faces the θ-block 240k.

Moreover, in the X-block 220k, a through-hole 226k with a circular cross section for the shaft 280k to be inserted therein is provided, penetrating the X-block 220k in the Z-direction. The through-hole 226k in the X-block 220k has a larger inner diameter than the through-hole 208k in the unit base 200k.

On an upper surface of the θ-block 240k (the surface facing the X-block 220k), a cylindrical guide shaft 242k provided with a through-hole 244k for the shaft 280k to be inserted therein is provided upright. On an outer peripheral surface of the guide shaft 242k, two inner grooves 246k with a semicircular cross section are provided, spaced apart from each other in up and down direction (Z-direction) and plural balls 248k are arranged along the inner grooves 246k. The outer diameter of the guide shaft 242k is smaller than the inner diameter of the through-hole 226k in the X-block 220k. On an inner circumferential surface of the through-hole 226k, two outer grooves (not shown) facing the inner grooves 246k on the guide shaft 242k are provided. In the state where the guide shaft 242k is inserted in the through-hole 226k in the X-block 220k, the plural balls 248k are inserted between the inner grooves 246k on the guide shaft 242k and the corresponding outer grooves on the through-holes 226k, thus forming ring-shaped ball guides. As the balls 248k roll along the inner grooves 246k and the outer grooves, the θ-block 240k smoothly rotates relative to the X-block 220k.

Also, on the upper surface of the θ-block 240k, a pressure receiver stage 250k is provided upright at a position facing the piezoelectric motor 300θ. A ceramic pressure receiver 252k is mounted on an upper surface of the pressure receiver stage 250k, and the sliding portion 4 of the oscillating body 1 provided inside the piezoelectric motor 300θ is urged to the pressure receiver 252k.

On the θ-block 240k, the piezoelectric motor 300y to drive the Y-block 260k is mounted in the state where the lateral direction of the oscillating body 1 is aligned with the Y-direction and where the sliding portion 4 of the oscillating body 1 faces the Y-block 260k.

Moreover, on a lower surface of the θ-block 240k (the surface facing the Y-block 260k), two Y-rails 254k are provided extending parallel to the Y-direction. The two Y-rails 254k are spaced apart from each other in the X direction and in the Y-direction. On both lateral surfaces of the Y-rails 254k, inner grooves 256k with a semicircular cross section are formed.

On an upper surface of the Y-block 260k (the surface facing the θ-block 240k), two Y-rail props 262k corresponding to the two Y-rails 254k on the side of the θ-block 240k are provided, extending parallel to the Y-direction. The Y-rail props 262k have an upward concave cross section, and on inner lateral surfaces thereof, outer grooves 264k with a semicircular cross section facing the inner grooves 256k of the Y-rails 254k are formed. Plural balls 266k are arranged along the outer grooves 264k. In the state where the Y-rail props 262k are fitted with the corresponding Y-rails 254k, the plural balls 266k are inserted between the inner grooves 256k and the outer grooves 264k, thus forming ball guides on both sides of each Y-rail 254k. As the balls 266k roll along the inner grooves 256k and the outer grooves 264k, the Y-block 260k smoothly moves relative to the θ-block 240k.

Also, on the upper surface of the Y-block 260k, a ceramic pressure receiver 268k is mounted at a position facing the piezoelectric motor 300y, and the sliding portion 4 of the oscillating body 1 provided inside the piezoelectric motor 300y is urged to the pressure receiver 268k. Moreover, a cylindrical shaft support portion 270k that supports the shaft 280k movably in the Z-direction is provided on the Y-block 260k.

In the moving mechanism 150k configured as described above, by applying a voltage to the oscillating body 1 of the piezoelectric motor 300x, of the three piezoelectric motors 300k, the X-block 220k can be moved in the X-direction relative to the unit base 200k. Also, by applying a voltage to the oscillating body 1 of the piezoelectric motor 300θ, the θ-block 240k can be rotated in the θ-direction relative to the X-block 220k. Moreover, by applying a voltage to the oscillating body 1 of the piezoelectric motor 300y, the Y-block 260k can be moved in the Y-direction relative to the θ-block 240k.

As described in the first embodiment, the piezoelectric motor 300x drives the X-block 220k, utilizing elliptical motion. That is, as shown in FIG. 14, the piezoelectric motor 300x is fixed on the side of the X-block 220k, with the lateral direction (bending direction) of the oscillating body 1 being aligned with the X-direction, and generates elliptical motion in the state where the sliding portion 4 of the oscillating body 1 is urged to the pressure receiver 210k of the unit base 200k. Thus, the sliding portion repeats an operation of moving toward one of bending directions in the state of being urged to the pressure receiver 210k when the oscillating body 1 expands, and returning to the original position while being spaced apart from the pressure receiver 210k when the oscillating body 1 contracts. As a result, a frictional force acting between the pressure receiver 210k and the sliding portion 4 causes the X-block 220k to move in the other of the bending directions (X-directions) relative to the unit base 200k.

The piezoelectric motor 300θ is fixed on the side of the X-block 220k, and the sliding portion 4 of the oscillating body 1 is urged to the pressure receiver 252k on the pressure receiver stage 250 provided on the side of the θ-block 240k. Therefore, when the piezoelectric motor 300θ is operated, a frictional force acting between the sliding portion 4 and the pressure receiver 252k causes the θ-block 240k to rotate in the θ-direction relative to the X-block 220k.

The piezoelectric motor 300y is fixed on the side of the θ-block 240k, with the lateral direction (bending direction) of the oscillating body 1 being aligned with the Y-direction, and the sliding portion 4 of the oscillating body 1 is urged to the pressure receiver 268k provided on the side of the Y-block 260k. Therefore, when the piezoelectric motor 300y is operated, a frictional force acting between the sliding portion 4 and the pressure receiver 268k causes the Y-block 260k to move in the Y-direction relative to the θ-block 240k. Thus, in the electronic component inspection device 1k, the position and attitude of the electronic component 70 gripped by the grip portion 142k can be fine-tuned by operating the piezoelectric motor 300x, the piezoelectric motor 300θ and the piezoelectric motor 300y of the moving mechanism 150k. Moreover, such piezoelectric motors 300k can be easily reduced in size compared with an electromagnetic motor that utilizes an electromagnetic force to rotate a rotor, and can directly transmit a drive force without having in-between gears or the like. Therefore, by using the piezoelectric motors 300k as actuators of the moving mechanism 150k, the moving mechanism 150k can be reduced in size.

Here, in the moving mechanism 150k, the X-block 220k, the θ-block 240k and the Y-block 260k are provided to be movable in different directions from one another (X-direction, θ-direction and Y-direction) and each block (220k, 240k, 260k) may wobble due to application of a load or the like. Particularly the X-block 220k on the side close to the unit base 200k supporting the entire moving mechanism 150k can easily wobble because the weight of the θ-block 240k and the Y-block 260k is applied thereon. As the wobbling of the X-block 220k is transmitted to the θ-block 240k and the Y-block 260k following the movement of the X-block 220k, the moving mechanism 150k wobbles substantially as a whole. Thus, in the moving mechanism 150k, the wobbling is restrained in the following manner.

As described above, the plural balls 206k are inserted between the outer grooves 204k formed on the X-rail prop 202k on the side of the unit base 200k and the inner grooves 224k formed on the X-rail 222k on the side of the X-block 220k, and these plural balls 206k form the ball guides parallel to the X-direction on both sides of the X-rail 222k (see FIG. 15). As the plural balls 206k roll along the two lines of ball guides, the X-block 220k smoothly moves relative to the unit base 200k. Hereinafter, a plane including the two lines of ball guides is called a “movement plane”. For the balls 206k to roll smoothly, there is a slight gap (play) between the balls 206k, and the inner grooves 224k and the outer grooves 204k.

The piezoelectric motor 300x mounted on the lateral surface of the X-block 220k is fixed in the state where the lateral direction (bending direction) of the built-in oscillating body 1 is aligned with the X-direction and where the upper end side (the side where the sliding portion 4 is provided) is inclined opposite to the X-block 220k. The oscillating body 1 is urged in the longitudinal direction (expanding/contracting direction) by the urging spring 6, and the sliding portion 4 is urged to the pressure receiver 210k on the unit base 200k. Therefore, the direction in which the sliding portion 4 of the oscillating body 1 is urged to the pressure receiver 210k (urging direction) is inclined at a predetermined angle (in the illustrated example, 75 degrees) to the movement plane.

The pressure receiver 210k is formed substantially in the shape of a rectangular parallelepiped and is embedded in the unit base 200k in the state where the lower surface thereof (the surface that the sliding portion 4 of the oscillating body 1 abuts against) is orthogonal to the urging direction of the oscillating body 1. Thus, even when the sliding portion 4 of the oscillating body 1 is obliquely urged to the lower surface of the unit base 200k, the position of the pressure receiver 210k will not be shifted in horizontal direction (Y-direction) by the urging force, and the frictional force acting between the sliding portion 4 and the pressure receiver 210k can cause the X-block 220k to move accurately relative to the unit base 200k. Also, in the moving mechanism 150k, the unit base 200k is made of a resin material, whereas the pressure receiver 210k is made of a material with a higher hardness than the resin material, such as a ceramic or metal material. Therefore, wear of the pressure receiver 210k due to the frictional force acting between the sliding portion 4 and the pressure receiver 210k can be restrained.

Here, the X-block 220k receives a counterforce in the direction opposite to the urging direction as the sliding portion 4 of the oscillating body 1 provided inside the piezoelectric motor 300x is urged to the pressure receiver 210k of the unit base 200k. This counterforce includes a component parallel to the movement plan and to the right in FIG. 15 and a component perpendicular to the movement plane and downward in FIG. 15. As the X-block 220k receives the counterforce parallel to the movement plane, the gap between the balls 206k, and the inner groove 224k and the outer groove 204k, is narrowed in the ball guide on the farther side from the piezoelectric motor 300x (on the right-hand side in FIG. 15), of the ball guides on both sides of the X-rail 222k. Thus, the balls 206k are held between the inner groove 224k and the outer groove 204k.

In the ball guide on the closer side to the piezoelectric motor 300x (on the left-hand side in FIG. 15), though the space between the inner groove 224k and the outer groove 204k expands, the X-block 220k receives the counterforce perpendicular to the movement plane, thus generating a moment to rotate the X-block 220k downward about the ball guide with the narrowed gap on the right-hand side in FIG. 15. Therefore, the balls 206k are held between the upper end side of the inner groove 224k and the lower end side of the outer groove 204k.

As described above, in the moving mechanism 150k, by inclining the urging direction of the oscillating body 1 relative to the movement plane, the balls 206k can be held between the inner groove 224k and the outer groove 204k in both of the ball guides on both sides of the X-rail 222k. Also, the balls 206k are held in different holding directions, that is, in one of the ball guides, the balls 206k are held in the direction parallel to the movement plane, whereas in the other ball guide, the balls 206k are held in the direction perpendicular to the movement plane. Therefore, even if a load from an arbitrary direction is applied to the X-block 220k, wobbling of the X-block 220k can be restrained. By thus restraining the wobbling of the X-block 220k which is arranged on the closer side to the unit base 200k and to which the weight of the θ-block 240k and the Y-block 260k is applied, the overall rigidity of the moving mechanism 150k can be increased.

In the moving mechanism 150k, the X-block 220k moving in the X-direction is arranged at an upper position close to the unit base 200k, and the Y-block 260k moving in the Y-direction is arranged at a lower position far from the unit base 200k. This is for the following reasons. First, as described above, in the electronic component inspection device 1k, the first hand unit 92k having the built-in moving mechanism 150k is mounted on the first hand unit support portion 913k, and the first hand unit 92k can be moved in the Y-direction by moving the second frame 912k supporting the first hand unit support portion 913k. When moving the electronic component 70 to the inspection position, the second frame 912k is moved in the Y-direction and therefore an inertial force in the Y-direction acts on the moving mechanism 150k. Since no inertial force in the moving direction acts on the X-block 220k movable in the X-direction orthogonal to the Y-direction, the arrangement of the X-block 220k at the upper position close to the unit base 200k enables prevention of misalignment (slip in the moving direction) of the X-block 220k due to an inertial force even when the weight of the θ-block 240k and the Y-block 260k is applied to the X-block 220k.

An inertial force in the moving direction acts on the Y-block 260k movable in the Y-direction. However, as the Y-block 260k is arranged at the lower position where the weight of the other blocks (220k, 240k) is not applied, a large inertial force will not act on the Y-block 260k and misalignment (slip in the moving direction) of the Y-block 260k can be restrained. As a result, there is no need to add a braking mechanism or the like to prevent misalignment of the Y-block 260k due to an inertial force, and the moving mechanism 150k can be reduced in size.

Moreover, in the moving mechanism 150k, the θ-block 240k is provided between the X-block 220k and the Y-block 260k, and the piezoelectric motor 300θ to drive the θ-block 240k is arranged, with the lateral direction (bending direction) of the built-in oscillating body 1 aligned with the X-direction. As the piezoelectric motor 300θ is arranged in this manner, even when an inertial force in the Y-direction acts on the moving mechanism 150k due to the movement of the second frame 912k, the direction in which the frictional force acts between the sliding portion 4 of the oscillating body 1 and the pressure receiver 252k (the bending direction of the oscillating body 1) and the direction of inertial doe not overlap each other. Therefore, misalignment (slip in the θ-direction) of the θ-block 240k due to an inertial force can be restrained.

The controller 10k is configured to be able to control each of the four first hand units 92k separately via the positioning mechanism 110. Therefore, positioning (position correction) of the four electronic components 70 held by the respective first hand units 92k can be carried out separately for each electronic component. Similarly, the controller 10k is configured to be able to control each of the four second hand units 93k separately via the positioning mechanism 110. Therefore, positioning (position correction) of the four electronic components 70 held by the respective second hand units 93k can be carried out separately for each electronic component.

### Collection Robot

The collection robot 8k is a robot for relocating the electronic component 70 that is already inspected and accommodated on the tray 43k provided on the first shuttle 4k and the tray 53k provided on the second shuttle 5k, to the collection tray 3k.

The collection robot 8k is configured similarly to the supply robot 7k. That is, the collection robot 8k has a support frame 82k supported on the pedestal 11k and having a rail 821k extending in the Y-direction, a moving frame (Y-direction moving frame) 83k supported on the support frame 82k and movable in a reciprocating manner in the Y-direction relative to the support frame 82k, a hand unit support portion (X-direction moving frame) 84k supported on the moving frame 83k and movable in a reciprocating manner in the X-direction relative to the moving frame 83k, and plural hand units 85k supported on the hand unit support portion 84k. The configurations of these parts are similar to the configurations of the corresponding parts in the supply robot 7k and therefore will not be described further in detail.

Such a collection robot 8k carries the electronic component 70 from the trays 43k, 53k to the collection tray 3k in the following manner. Since the electronic component 70 is carried from each of the trays 43k, 53k to the collection tray 3k in similar manners to each other, the carrying of the electronic component 70 from the tray 43k will be described hereinafter as a representative example.

First, the first shuttle 4k is moved to the (+) side in the X-direction and the tray 43k is aligned with the collection tray 3k in the Y-direction. Next, the moving frame 83k is moved in the Y-direction so that the hand unit 85k is situated over the tray 43k, and the hand unit support portion 84k is moved in the X-direction. Next, the holding portion of the hand unit 85k is lowered to contact the electronic component 70 on the supply tray 2k, and the holding portion is made to hold the electronic component 70.

Next, the holding portion of the hand unit support portion 84k is raised and the electronic component 70 held on the tray 43k is removed from the tray 43k. Then, the moving frame 83k is moved in the Y-direction so that the hand unit 85k is situated over the collection tray 3k, and the hand unit support portion 84k is moved in the X-direction. Next, the holding portion of the hand unit support portion 84k is lowered and the electronic component 70 held by the holding portion is arranged inside the pocket 31k in the collection tray 3k. Next, the suction state of the electronic component 70 is canceled to detach the electronic component 70 from the holding portion.

Thus, the carrying (relocation) of the electronic component 70 from the tray 43k to the collection tray 3k is completed.

Here, the electronic components 70 that are already inspected and accommodated on the tray 43k may include a defective product that cannot exhibit predetermined electrical characteristics. Therefore, for example, two collection trays 3k may be prepared so that one can be used to accommodate a good product that satisfies predetermined electrical characteristics while the other can be used to collect the defective product. Alternatively, if a single collection tray 3k is used, a predetermined pocket 31k may be used as a pocket to accommodate the defective product. Thus, the good product and the defective product can be clearly discriminated.

In such a case, for example, if three of the four electronic components 70 held in the four hand units 85k are good products and the remaining one is a defective product, the collection robot 8k carries the three good products to the collection tray for good product and carries the one defective product to the collection tray for defective product. Since each hand unit 85k is driven (each electronic component 70 is sucked) independently, such an operation can be easily carried out.

### Controller

The controller 10k has a drive control unit 102k and an inspection control unit 101k. The drive control unit 102k controls, for example, the movement of the supply tray 2k, the collection tray 3k, the first shuttle 4k and the second shuttle 5k, and mechanical driving of the supply robot 7k, the collection robot 8k, the inspection robot 9k, the first camera 600k and the second camera 500k or the like. The inspection control unit 101k carries out inspection of electrical characteristics of the electronic component 70 arranged in the inspection socket 6k, based on a program stored in a memory, not shown.

### Positioning Mechanism

As shown in FIG. 16, the positioning mechanism 110 is a positioning mechanism employing the basic configuration of the drive device 100 according to the first embodiment and includes two drive units 111a, 111b.

The drive unit 111a is configured to drive each of the four first hand units 92k. The drive unit 111b is configured to drive each of the four second hand units 93k. Each drive unit can move and arrange the electronic component 70 to a predetermined position.

The drive unit 111a has a drive circuit 90a, twelve relays, that is, four relays 21x, four relays 21y and four relays 21θ, and twelve piezoelectric motors, that is, four piezoelectric motors 300x, four piezoelectric motors 300y and four piezoelectric motors 300θ. To each relay 21x, the corresponding piezoelectric motor 300x is connected. To each relay 21y, the corresponding piezoelectric motor 300y is connected. To each relay 21θ, the corresponding piezoelectric motor 300θ is connected. Switching the relays 21x, 21y, 21θ respectively provides the state of electrical connection or cut-off between the piezoelectric motors 300x, 300y, 300θ and the drive circuit 90b.

Similarly, the drive unit 111b has a drive circuit 90b, twelve relays, that is, four relays 21x, four relays 21y and four relays 21θ, and twelve piezoelectric motors, that is, four piezoelectric motors 300x, four piezoelectric motors 300y and four piezoelectric motors 300θ. To each relay 21x, the corresponding piezoelectric motor 300x is connected. To each relay 21y, the corresponding piezoelectric motor 300y is connected. To each relay 21θ, the corresponding piezoelectric motor 300θ is connected. Switching the relays 21x, 21y, 21θ respectively provides the state of electrical connection or cut-off between the piezoelectric motors 300x, 300y, 300θ and the drive circuit 90b.

In this manner, the drive unit 111a of the positioning mechanism 110 drives the twelve piezoelectric motors by the common drive circuit 90a. Similarly, the drive unit 111b drives the twelve piezoelectric motors by the common drive circuit 90b. Therefore, the number of the drive circuits 90 and the number of wires can be reduced, compared with the number of the piezoelectric motors. Thus, a reduction in the size, weight and cost of the positioning mechanism 110 can be realized.

Since a reduced number of wires suffices between the drive circuits 90a, 90b and the piezoelectric motors 300x, 300y, 300θ arranged at positions spaced apart from each other, the load due to the weight of the wires and the bundle of wires is restrained to a low level. Therefore, positioning is easier to carry out and more accurate positioning can be carried out.

Next, a method for positioning the electronic component 70 gripped by the first hand unit 92k (visual alignment) will be described. The positioning method described below is a non-limiting example. The method for positioning the electronic component 70 gripped by the second hand unit 93k is similar to this method and therefore will not be described further.

The electronic component 70 that is accommodated on the tray 42k and yet to be inspected is gripped by the grip portion 142k. In the course of moving from directly above the tray 42k to directly above the inspection socket 6k, the first hand unit 92k passes directly above the first camera 600k. When the first hand unit 92k passes directly above the first camera 600k, the first camera 600k picks up an image to capture the electronic component 70 held by the first hand unit 92k and the device mark provided on the first hand unit 92k. Image data thus obtained is transmitted to the controller 10k and image recognition is carried out by the controller 10k.

Specifically, in the image recognition, predetermined processing is carried out on the image data acquired from the first camera 600k, and the relative position and the relative angle between the device mark on the first hand unit 92k and the electronic component 70 are calculated. The resulting relative position and relative angle are compared with a reference position and a reference angle that indicate an appropriate positional relation between the device mark and the electronic component 70, and an “amount of position shift” between the relative position and the reference position and an “amount of angle shift” between relative angle and the reference angle are calculated. The reference position and the reference angle refer to a position where the external terminal of the electronic component 70 is suitably connected to the probe pins 62k in the inspection socket 61k when the first hand unit 92k is arranged at a preset inspection origin position.

The controller 10k then drives the piezoelectric motors 300x, 300y, 300θ according to need, based on the amount of position shift and the amount of angle shift that are found, and corrects the position and attitude (angle) of the electronic component 70 so that the relative position and relative angle meet the reference position and reference angle.

Specifically, if there is an amount of position shift between the relative position and the reference position, the controller 10k drives the piezoelectric motor 300x to move the X-block 220k in the X-direction relative to the unit base 200k, drives the piezoelectric motor 300y to move the Y-block 260k in the Y-direction relative to the θ-block 240k, or carries out one of these movements of the X-block 220k and the Y-block 260k, thus aligning the relative position to the reference position. If there is an amount of angle shift between the relative angle and the reference angle, the controller 10k drives the piezoelectric motor 300θ to rotate the θ-block 240k in the θ-direction relative to the X-block 220k, thereby aligning the relative angle to the reference angle. Through the above control, the gripped electronic component 70 can be positioned.

### Inspection Method by Inspection Device

Next, a method for inspecting the electronic component 70 by the electronic component inspection device 1k will be described. The inspection method described below, particularly the procedure for carrying the electronic component 70, is a non-limiting example.

### Step 1

First, as shown in FIG. 17, the supply tray 2k having the electronic component 70 accommodated in each pocket 21k is carried into the area S, and the first and second shuttles 4k, 5k are moved to the (−) side in the X-direction so that each of the trays 42k, 52k is aligned with the supply tray 2k on the (+) side in the Y-direction.

### Step 2

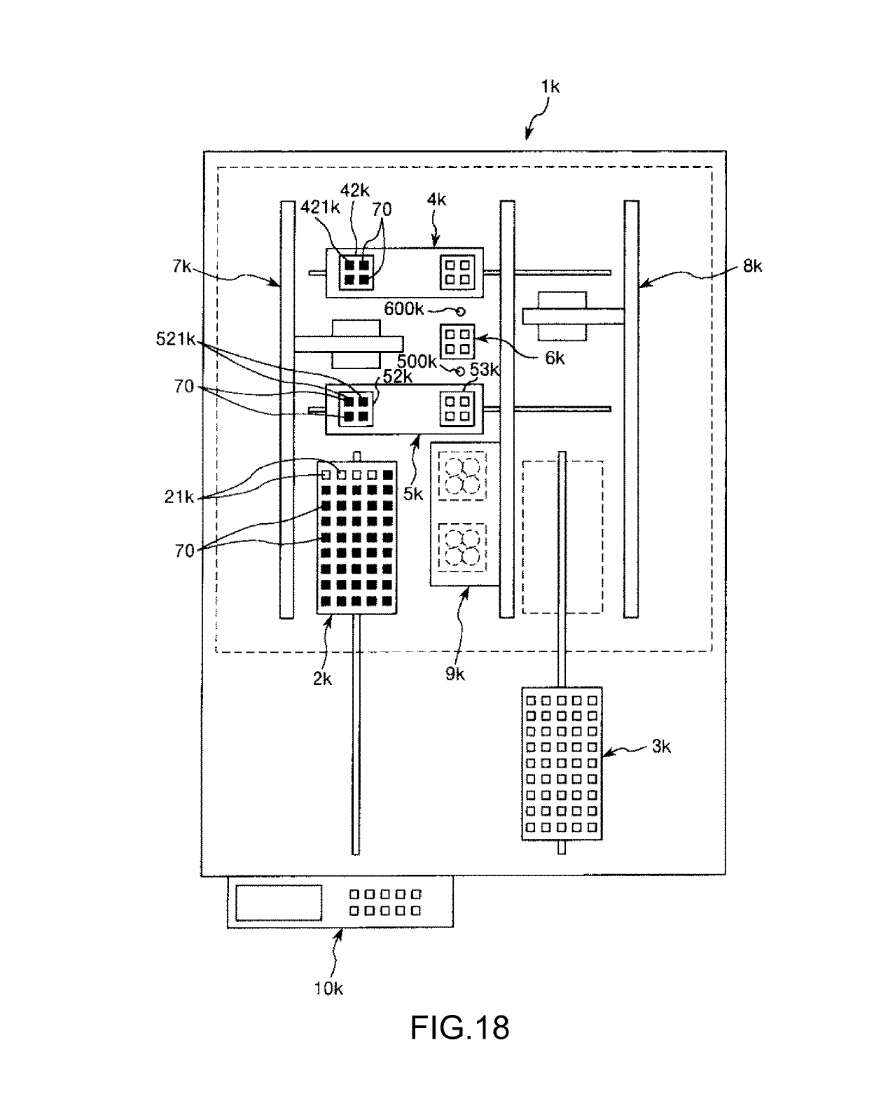

Next, as shown in FIG. 18, the electronic components 70 accommodated on the supply tray 2k are relocated to the trays 42k, 52k by the supply robot 7k, thus accommodating the electronic components 70 in the respective pockets 421k, 521k on the trays 42k, 52k.

### Step 3

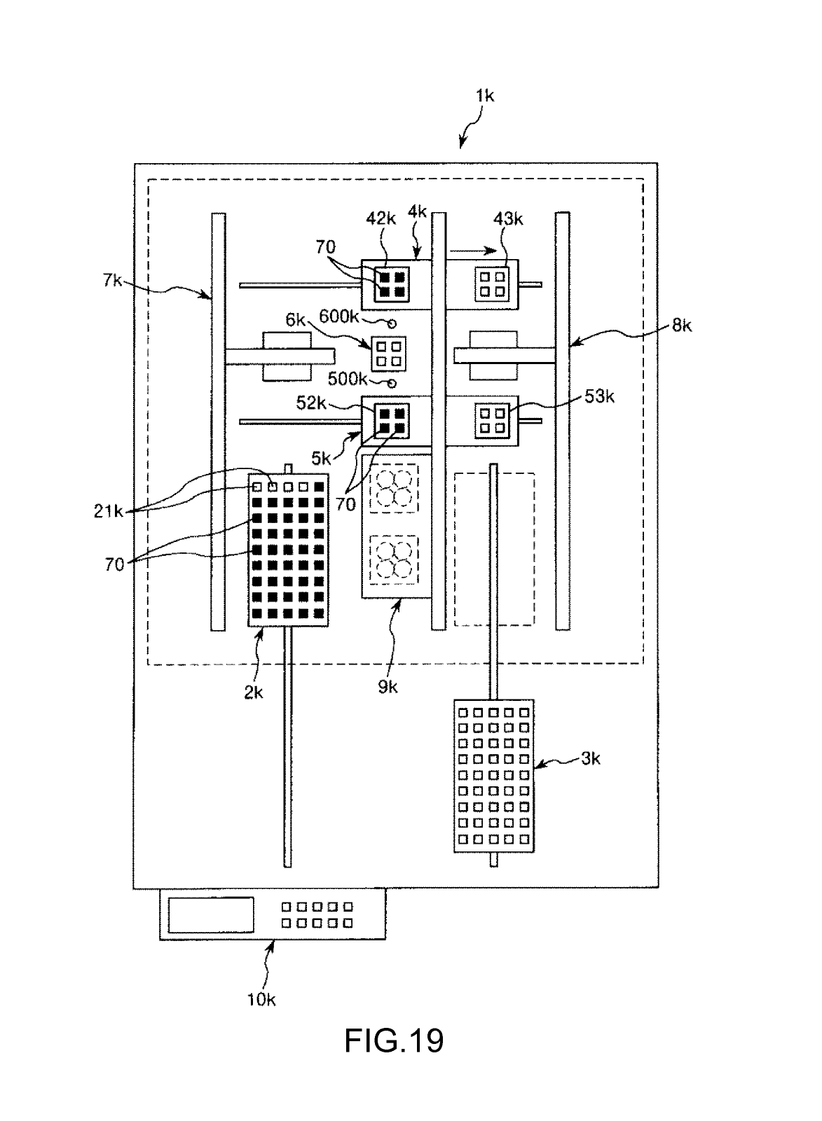

Next, as shown in FIG. 19, both of the first and second shuttles 4k, 5k are moved to the (+) side in the X-direction so that the tray 42k is aligned with the inspection socket 6k on the (+) side in the Y-direction while the tray 52k is aligned with the inspection socket 6k on the (−) side in the Y-direction.

### Step 4

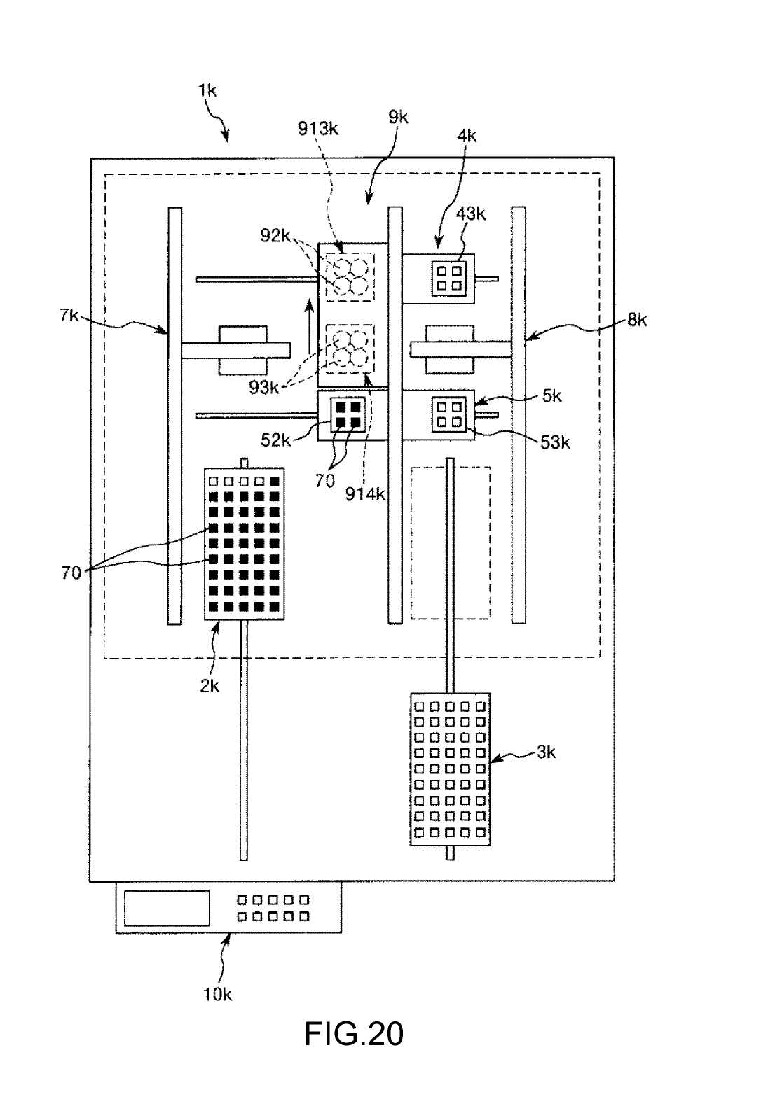

Next, as shown in FIG. 20, the first and second hand unit support portions 913k, 914k are moved in a unified manner to the (+) side in the Y-direction so that the first hand unit support portion 913k is situated directly above the tray 42k while the second hand unit support portion 914k is situated directly above the inspection socket 6k.

After that, each first hand unit 92k holds the electronic components 70 accommodated on the tray 42k. Specifically, first, each first hand unit 92k moves to the (−) side in the Z-direction and sucks and holds the electronic components 70 accommodated on the tray 42k. Then, each first hand unit 92k moves to the (+) side in the Z-direction. Thus, the electronic component 70 held by each first hand unit 92k is taken out of the tray 42k.

### Step 5

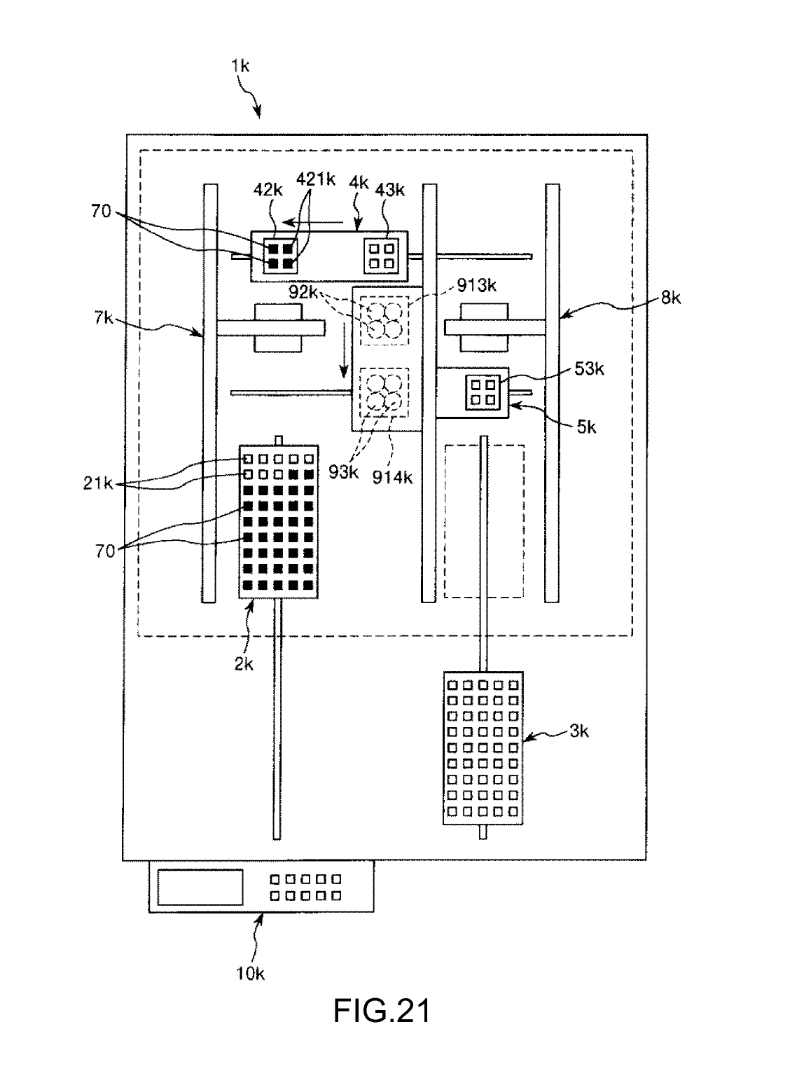

Next, as shown in FIG. 21, the first and second hand unit support portions 913k, 914k are moved in a unified manner to the (−) side in the Y-direction so that the first hand unit support portion 913k is situated directly above the inspection socket 6k (inspection origin position) while the second hand unit support portion 914k is situated directly above the tray 52k. During this movement, the first hand unit support portion 913k (each first hand unit 92k) passes directly above the first camera 600k, and at this time, the first camera 600k picks up an image to capture the electronic component 70 held by each first hand unit 92k and a device mark 949k on each first hand unit 92k. Then, based on the image data obtained by the image pickup, the controller 10k performs positioning (visual alignment) of each electronic component 70 separately. The positioning (visual alignment) refers to recognition of the relative position between the inspection socket 61k and the socket mark, recognition of the relative position between the socket mark and the device mark 949k, recognition of the relative position between the device mark 949k and the electronic component 70, and positioning. This results in positioning of the inspection socket 61k and the electronic component 70 between each other.

In parallel with the movement of the first and second hand unit support portions 913k, 914k and the positioning of the electronic component 70, the following operation is also carried out. First, the first shuttle 4k is moved to the (−) side in the X-direction so that the tray 43k is aligned with the inspection socket 6k in the Y-direction while the tray 42k is aligned with the supply tray 2k in the Y-direction. Next, the electronic components 70 accommodated on the supply tray 2k are relocated onto the tray 42k by the supply robot 7k, thus accommodating the electronic components 70 in each pocket 421k on the tray 42k.

### Step 6

Next, the first hand unit support portion 913k is moved to the (−) side in the Z-direction and the electronic component 70 held by each first hand unit 92k is arranged in each inspection socket 61k of the inspection socket 6k. At this time, the electronic component 70 is pressed against the inspection socket 61k with a predetermined inspection pressure (pressure). Thus, the external terminal of the electronic component 70 and the probe pins 62k provided in the inspection socket 61k are electrically connected to each other, and in this state, electrical characteristics of the electronic component 70 in each inspection socket 61k are inspected by the inspection control unit 101k of the controller 10k. As the inspection is finished, the first hand unit support portion 913k is moved to the (+) side in the Z-direction and the electronic component 70 held by each first hand unit 92k is taken out of the inspection socket 61k.

In parallel with this operation (inspection of the electronic component 70), each second hand unit 93k supported on the second hand unit support portion 914k holds the electronic components 70 accommodated on the tray 52k and takes out the electronic components 70 from the tray 52k.

### Step 7

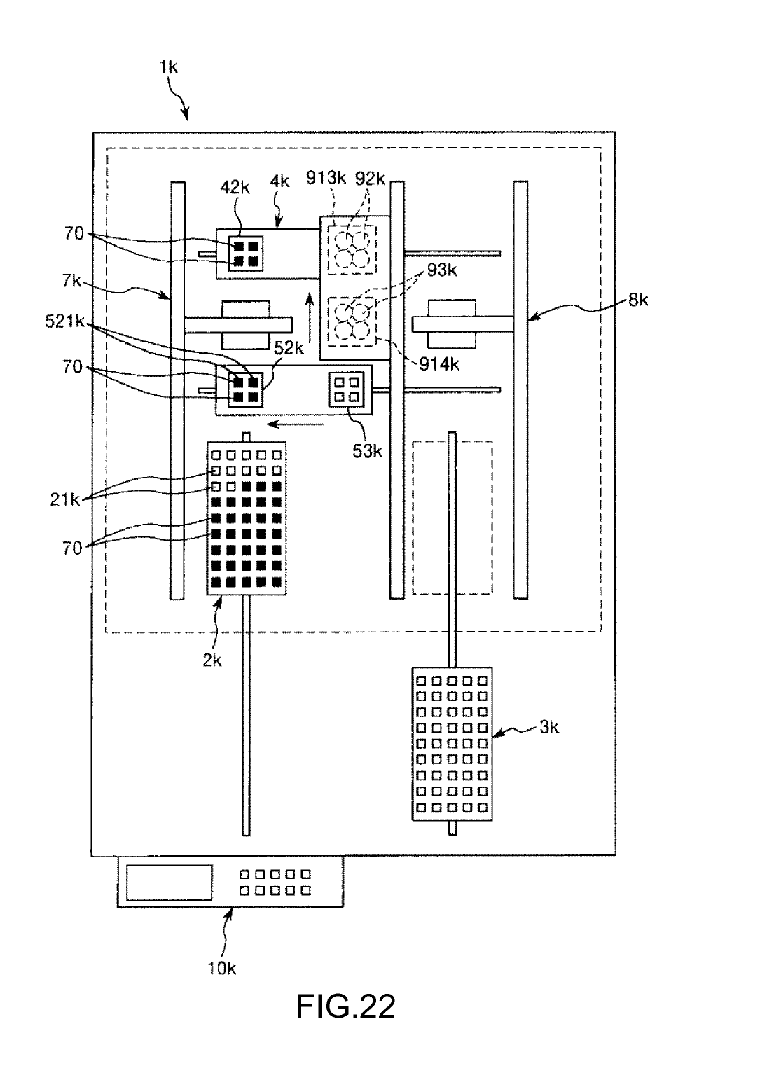

Next, as shown in FIG. 22, the first and second hand unit support portions 913k, 914k are moved in a unified manner to the (+) side in the Y-direction so that the first hand unit support portion 913k is situated directly above the tray 43k of the first shuttle 4k while the second hand unit support portion 914k is situated directly above the inspection socket 6k (inspection origin position). During this movement, the second hand unit support portion 914k (each second hand unit 93k) passes directly above the second camera 500k, and at this time, the second camera 500k picks up an image to capture the electronic component 70 held by each second hand unit 93k and the device mark on each second hand unit 93k. Then, based on the image data obtained by the image pickup, the controller 10k performs positioning of each electronic component 70 separately by the above method.

In parallel with the movement of the first and second hand unit support portions 913k, 914k, the following operation is also carried out. First, the second shuttle 5k is moved to the (−) side in the X-direction so that the tray 53k is aligned with the inspection socket 6k in the Y-direction while the tray 52k is aligned with the supply tray 2k in the Y-direction. Next, the electronic components 70 accommodated on the supply tray 2k are relocated onto the tray 52k by the supply robot 7k, thus accommodating the electronic components 70 in each pocket 521k on the tray 52k.

### Step 8

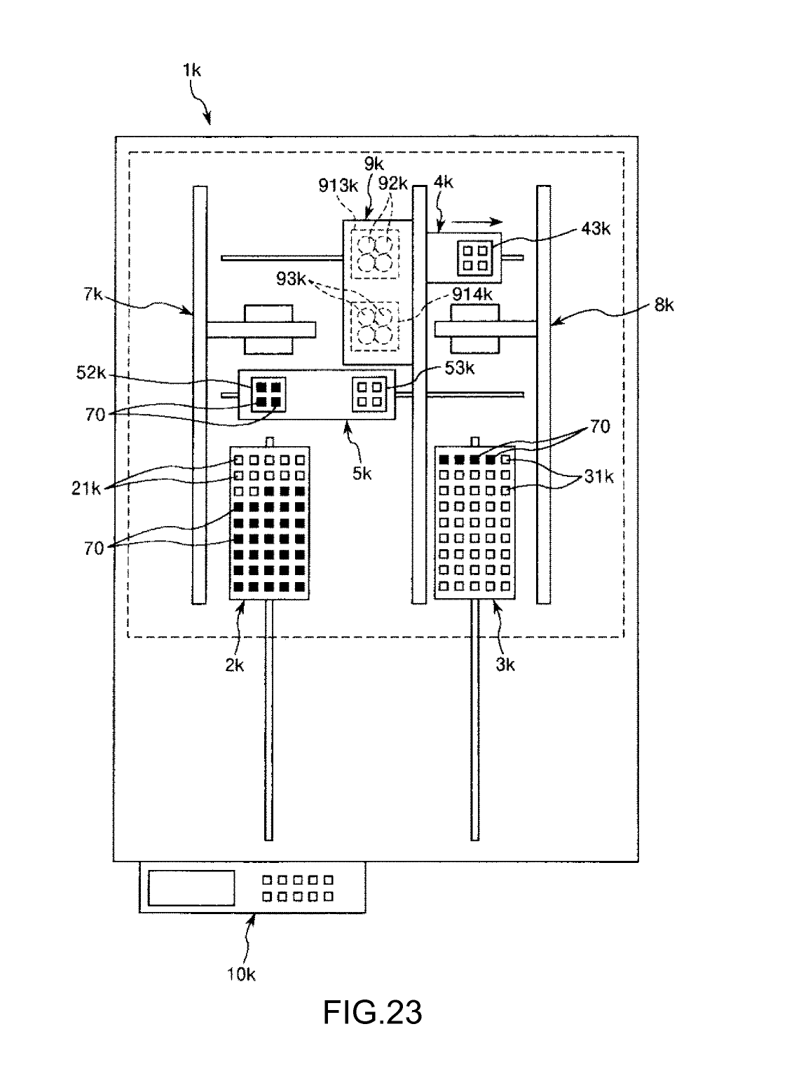

Next, as shown in FIG. 23, the second hand unit support portion 914k is moved to the (−) side in the Z-direction and the electronic component 70 held by each second hand unit 93k is arranged in each inspection socket 61k of the inspection socket 6k. Then, electrical characteristics of the electronic component 70 in each inspection socket 61k are inspected by the inspection control unit 101k. As the inspection is finished, the second hand unit support portion 914k is moved to the (+) side in the Z-direction and the electronic component 70 held by each second hand unit 93k is taken out of the inspection socket 61k.

In parallel with this operation, the following operation is carried out.

First, the electronic component 70 that is already inspected and held by each first hand unit 92k is accommodated in each pocket 431k of the tray 43k. Specifically, each first hand unit 92k is moved to the (−) side in the Z-direction, and after the electronic component 70 held thereby is arranged in the pocket 431k, the suction state is canceled. Next, each first hand unit 92k is moved to the (+) side in the Z-direction. Thus, the electronic component 70 that is previously held by each first hand unit 92k is accommodated on the tray 43k.

Next, the first shuttle 4k is moved to the (+) side in the X-direction so that the tray 42k is aligned with the inspection socket 6k in the Y-direction and situated directly below the first hand unit support portion 913k (each first hand unit 92k) while the tray 43k is aligned with the collection tray 3k in the Y-direction. Next, each first hand unit 92k holds the electronic component 70 accommodated on the tray 42k. In parallel with this, the electronic component 70 that is already inspected and accommodated on the tray 43k is relocated to the collection tray 3k by the collection robot 8k.

### Step 9

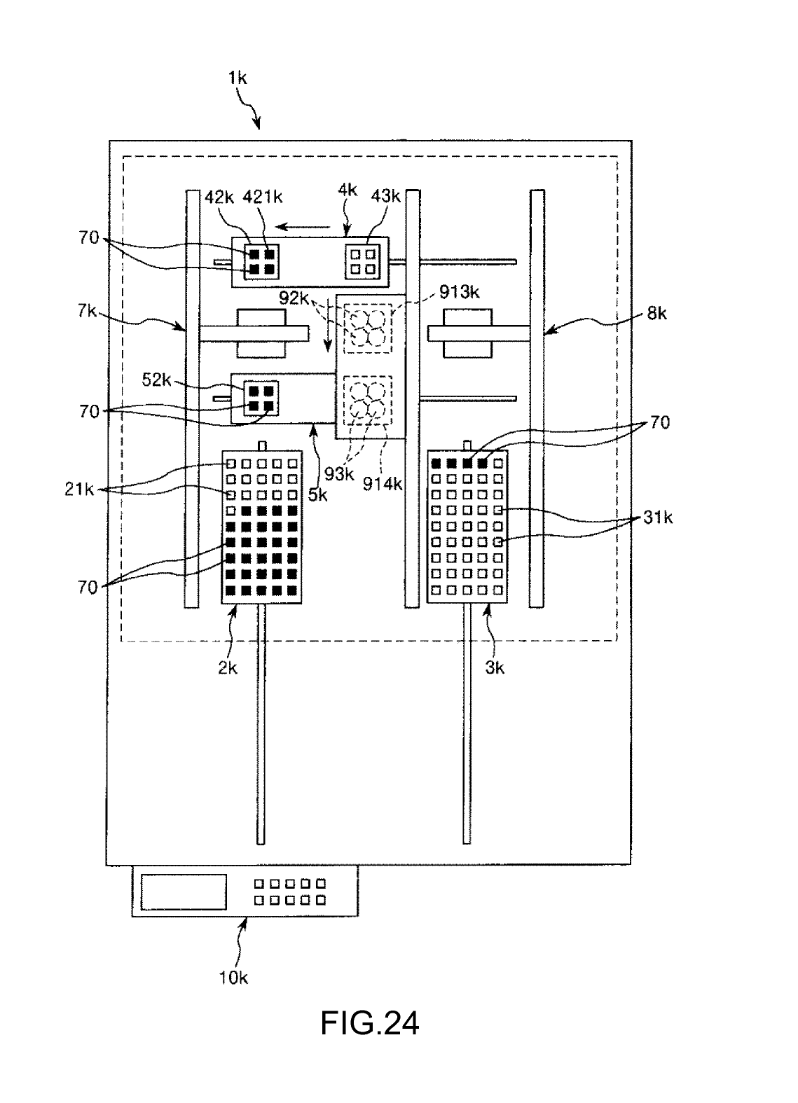

Next, as shown in FIG. 24, the first and second hand unit support portions 913k, 914k are moved in a unified manner to the (−) side in the Y-direction so that the first hand unit support portion 913k is situated directly above the inspection socket 6k (inspection origin position) while the second hand unit support portion 914k is situated directly above the tray 52k. At this time, too, positioning of the electronic component 70 held by the first hand unit 92k is carried out, as in the foregoing Step 5.

In parallel with the movement of the first and second hand unit support portions 913k, 914k, the following operation is also carried out. First, the first shuttle 4k is moved to the (−) side in the X-direction so that the tray 43k is aligned with the inspection socket 6k in the Y-direction while the tray 42k is aligned with the supply tray 2k in the Y-direction. Next, the electronic component 70 accommodated on the supply tray 2k is relocated onto the tray 42k by the supply robot 7k, thus accommodating the electronic component 70 in each pocket 421k of the tray 42k.

### Step 10

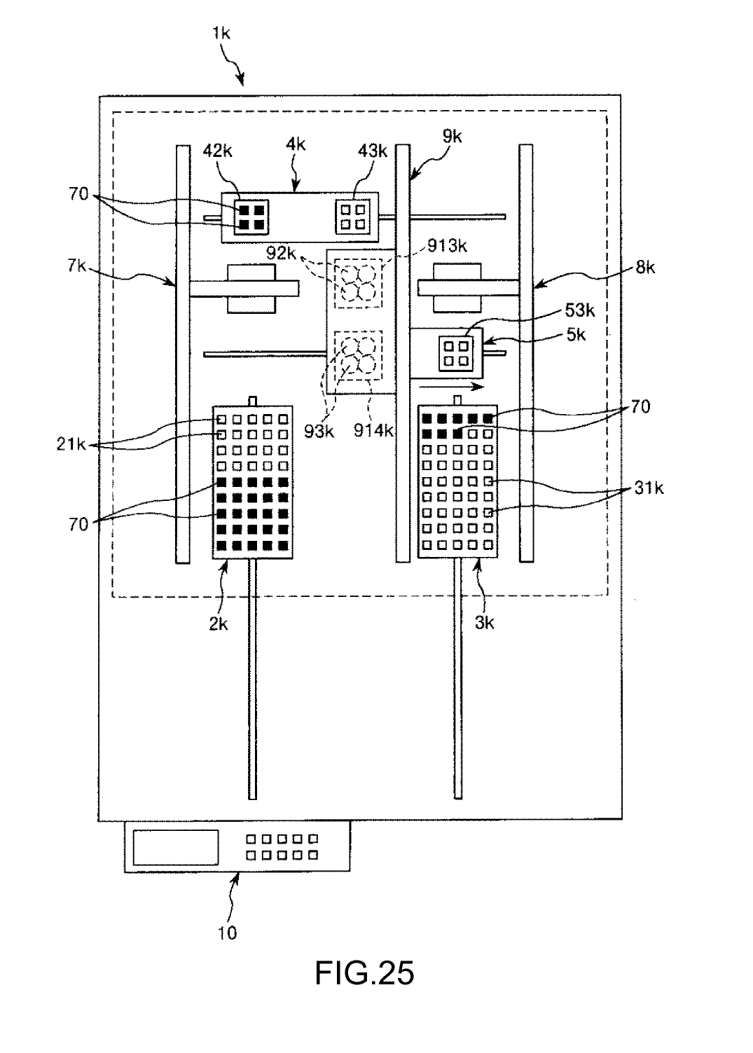

Next, as shown in FIG. 25, the first hand unit support portion 913k is moved to the (−) side in the Z-direction and the electronic component 70 held by each first hand unit 92k is arranged in each inspection socket 61k of the inspection socket 6k. Then, electrical characteristics of the electronic component 70 in each inspection socket 61k are inspected by the inspection control unit 101k. As the inspection is finished, the first hand unit support portion 913k is moved to the (+) side in the Z-direction and the electronic component 70 held by each first hand unit 92k is taken out of the inspection socket 61k.

In parallel with this operation, the following operation is carried out. First, the electronic component 70 that is already inspected and held by each second hand unit 93k is accommodated in each pocket 531k of the tray 53k. Next, the second shuttle 5k is moved to the (+) side in the X-direction so that the tray 52k is aligned with the inspection socket 6k in the Y-direction and situated directly below the second hand unit support portion 914k while the tray 53k is aligned with the collection tray 3k in the Y-direction. Next, each second hand unit 93k holds the electronic component 70 accommodated on the tray 52k. In parallel with this, the electronic component 70 that is already inspected and accommodated on the tray 53k is relocated onto the collection tray 3k by the collection robot 8k.

### Step 11

After that, the foregoing Steps 7 to 10 are repeated. When the relocation of all the electronic components 70 accommodated on the supply tray 2k to the first shuttle 4k is finished during this repetition, the supply tray 2k moved out of the area S. Then, after new electronic components 70 are supplied to the supply tray 2k or the supply tray 2k is replaced with another supply tray 2k already accommodating electronic components 70, the supply tray 2k is moved into the area S again. Similarly, when the electronic components 70 are accommodated in all the pockets 31k of the collection tray 3k during the repetition, the collection tray 3k moves out of the area S. Then, after the electronic components 70 accommodated on the collection tray 3k are removed or the collection tray 3k is replaced with another collection tray 3k that is empty, the collection tray 3k moves into the area S again.

According to the above method, the electronic component 70 can be inspected efficiently. Specifically, the inspection robot 9k has the first hand unit 92k and the second hand unit 93k. For example, in the state where the electronic component 70 held by the first hand unit 92k (the same applies to the second hand unit 93k) is inspected in the inspection socket 6k, in parallel with this inspection, the second hand unit 93k accommodates the electronic component 70 finished with inspection, onto the tray 53k, and stands by, holding the electronic component 70 to be inspected next. By thus carrying out different operations using the two hand units, time wasting can be reduced and the electronic component 70 can be inspected efficiently.

### Fourth Embodiment

### Robot Hand and Robot

Next, a robot hand and a robot according to a fourth embodiment will be described. The robot hand and the robot according to the fourth embodiment have a drive device having a similar configuration as the drive device according to the first embodiment, as a drive device for a joint portion. Hereinafter, this embodiment is described mainly in terms of the difference from each of the foregoing embodiments and description of similar elements is omitted.

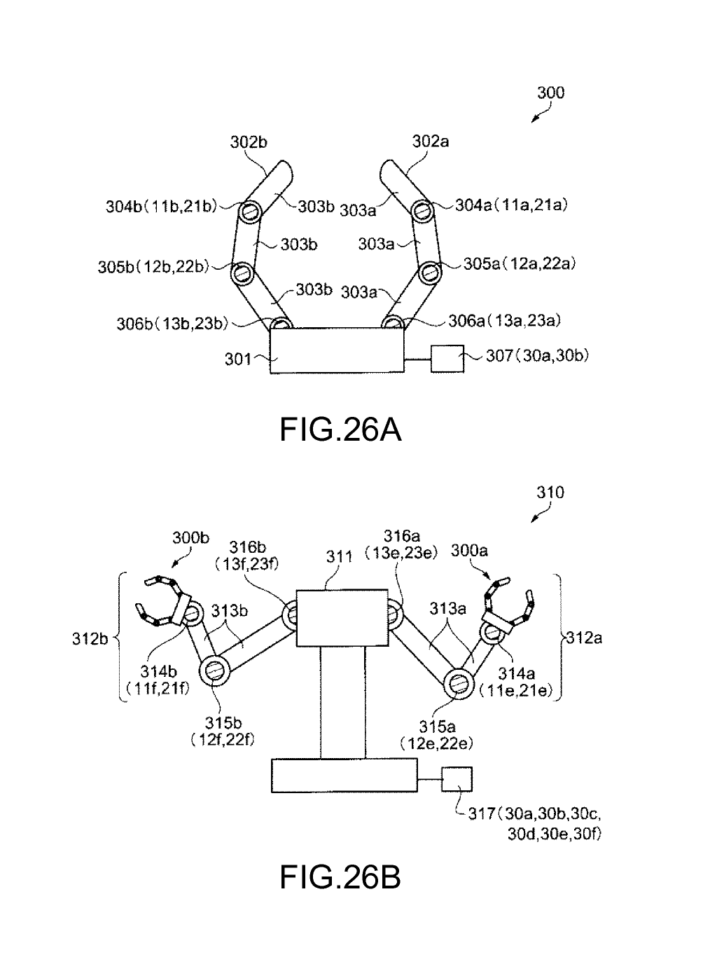

FIGS. 26A and 26B are schematic views showing the structures of the robot hand and the robot according to the fourth embodiment. FIG. 26A is a schematic view showing the structure of the robot hand. As shown in FIG. 26A, a robot hand 300 has a hand main body portion 301, two finger portions 302a, 302b, and a controller 307. The two finger portions 302a, 302b are installed on the hand main body portion 301.

The finger portion 302a includes three joint portions 304a, 305a, 306a as movable portions and three finger members 303a alternately connected to each other. The joint portions 304a, 305a, 306a are provided with piezoelectric motors 11a, 12a, 13a and relays 21a, 22a, 23a, respectively. The finger portion 302b includes three joint portions 304b, 305b, 306b as movable portions and three finger members 303b alternately connected to each other. The joint portions 304b, 305b, 306b are provided with piezoelectric motors 11b, 12b, 13b and relays 21b, 22b, 23b, respectively.

Drive circuits 30a, 30b are arranged in the controller 307. The piezoelectric motors 11a, 12a, 13a and the relays 21a, 22a, 23a are connected to the drive circuit 30a. Through switching of the relays 21a, 22a, 23a based on a select signal from the drive circuit 30a, the piezoelectric motors 11a, 12a, 13a are driven in a time division manner, thus rotating the joint portions 304a, 305a, 306a. Similarly, the piezoelectric motors 11b, 12b, 13b and the relays 21b, 22b, 23b are connected to the drive circuit 30b. Through switching of the relays 21b, 22b, 23b based on a select signal from the drive circuit 30b, the piezoelectric motors 11b, 12b, 13b are driven in a time division manner, thus rotating the joint portions 304b, 305b, 306b. Therefore, the finger portions 302a, 302b can be deformed in a desired form like human fingers.

FIG. 26B is a schematic view showing the structure of the robot. As shown in FIG. 26B, a robot 310 has a robot main body portion 311, two arm portions 312a, 312b, and a controller 317. The two arm portions 312a, 312b are installed on the robot main body portion 311.

The arm portion 312a includes three joint portions 314a, 315a, 316a as movable portions and two arm members 313a alternately connected to each other. The joint portions 314a, 315a, 316a are provided with piezoelectric motors 11e, 12e, 13e and relays 21e, 22e, 23e, respectively. One end of the arm portion 312a is installed on the robot main body portion 311, and a robot hand 300a is installed on the other end of the arm portion 312a. The robot hand 300a has a similar configuration to FIG. 26A.

The arm portion 312b includes three joint portions 314b, 315b, 316b as movable portions and two arm members 313b alternately connected to each other. The joint portions 314b, 315b, 316b are provided with piezoelectric motors 11f, 12f, 13f and relays 21f, 22f, 23f, respectively. One end of the arm portion 312b is installed on the robot main body portion 311, and a robot hand 300b is installed on the other end of the arm portion 312b. While the robot hand 300b has a similar configuration to FIG. 26A, the robot hand 300b includes three piezoelectric motors and three relays (not shown) connected to drive circuit 30c, 30d, respectively, in the joint portion.

The drive circuits 30a, 30b, 30c, 30d, 30e, 30f are arranged in the controller 317. The piezoelectric motors 11e, 12e, 13e and the relays 21e, 22e, 23e are connected to the drive circuit 30e. Through switching of the relays 21e, 22e, 23e based on a select signal from the drive circuit 30e, the piezoelectric motors 11e, 12e, 13e are driven in a time division manner, thus rotating the joint portions 314a, 315a, 316a.

Similarly, the piezoelectric motors 11f, 12f, 13f and the relays 21f, 22f, 23f are connected to the drive circuit 30f. Through switching of the relays 21f, 22f, 23f based on a select signal from the drive circuit 30f, the piezoelectric motors 11f, 12f, 13f are driven in a time division manner, thus rotating the joint portions 314b, 315b, 316b. Therefore, the arm portions 312a, 312b can be deformed in a desired form like human arms.

As described above, the configuration of the robot hand 300 and the robot 310 according to the fourth embodiment can achieve the following effects. The letters a, b, c, d and the like at the end of the reference numbers are omitted.

1. Since a drive device similar to the drive device 100 according to the first embodiment is provided for each joint portion, the number of the drive circuits 30 and the number of wires can be made smaller than the number of the piezoelectric motors 11, 12, 13. Also, since the piezoelectric motors are used, a braking mechanism that would be provided for each motor is not needed or a braking mechanism with a lower braking capability can be employed, compared with the case where electromagnetic motors or pulse motors area used. As a result, the robot hand 300 and the robot 310 can be reduced in the size, weight and cost.

2. Since a small number of wires suffices between the drive circuit 30 and the piezoelectric motors 11, 12, 13 that are arranged at positions spaced apart from each other, the load due to the weight of wires and the bundle of wires applied in deforming the finger portion 302 and the arm portion 312 is restrained to a low level. Therefore, the finger portion 302 of the robot hand 300 and the arm portion 312 of the robot 310 can perform more accurate operations.

It should be noted that the above embodiment is simply an example of embodiment of the invention and that arbitrary modifications and applications within the scope of the invention are possible. Examples of modifications will be described below.

### Fifth Embodiment

### Drive Device

Next, a drive device according to a fifth embodiment will be described. The drive device according to the fifth embodiment is different from the second embodiment in that the piezoelectric motor further includes a braking unit that performs braking on the movement of the moving portion. However, the other configurations are substantially similar. Hereinafter, this embodiment is described mainly in terms of the difference from the foregoing embodiment and description of similar elements is omitted.

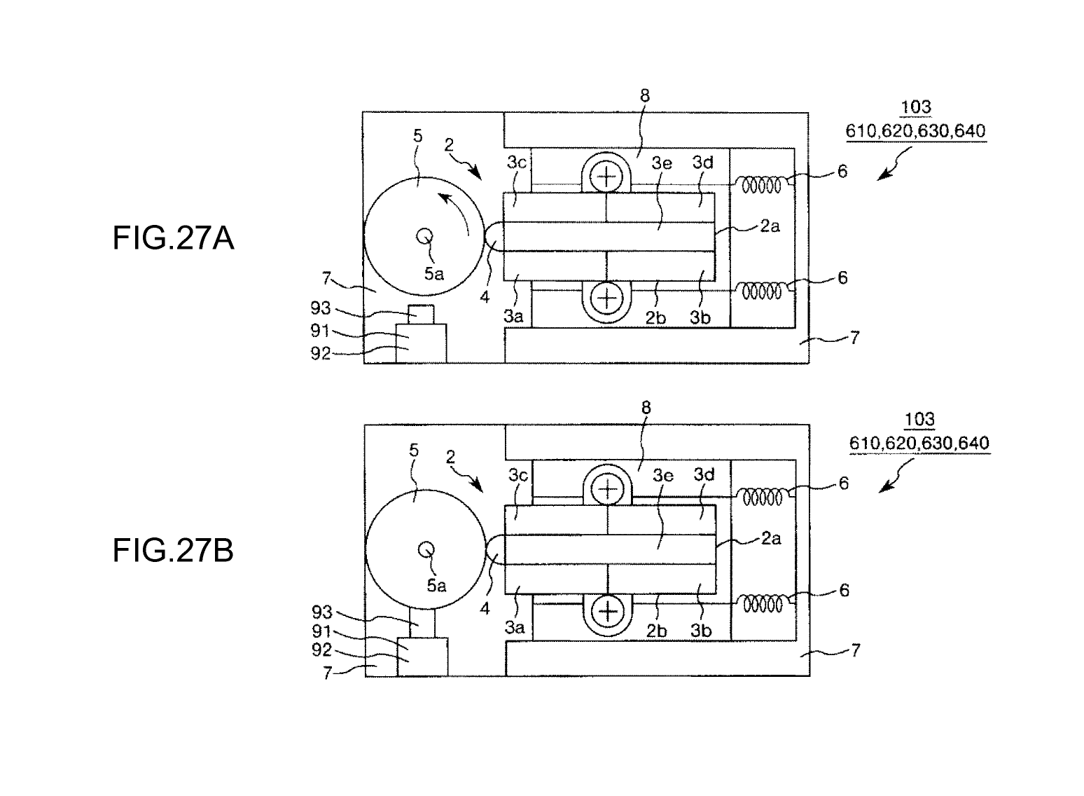

FIGS. 27A and 27B are schematic views showing the configuration of a piezoelectric motor used in the drive device according to the fifth embodiment.

In a drive device 103 according to the fifth embodiment, each of piezoelectric motors 610, 620, 630, 640 further includes a braking unit 91 that performs braking on the movement of the movable portion 50 (see FIG. 1). Since the piezoelectric motors 610, 620, 630, 640 are similar to one another, the piezoelectric motor 610 will be described hereinafter as a representative example.

The braking unit 91 of the piezoelectric motor 610 has a base portion 92 and an abutting portion 93 installed to be movable relative to the base portion 92, and is installed near the driven member 5. The braking unit 91 can take a first state where the abutting portion 93 is spaced apart from the lateral surface (circumferential surface) of the driven member 5 (see FIG. 27A) and a second state where the abutting portion 93 is abutting on the lateral surface of the driven member 5 (see FIG. 27B). The movement of the abutting portion 93 is carried out by driving of a motor, not shown, that is provided inside the braking unit 91.

When driving the piezoelectric motor 610, the abutting portion 93 of the braking unit 91 is spaced apart from the lateral surface of the driven member 5, as shown in FIG. 27A. Then, when stopping the piezoelectric motor 610, the abutting portion 93 of the braking unit 91 is pressed in contact with the lateral surface of the driven member 5, as shown in FIG. 27B. Thus, the driven member 5 stops and the movable portion 50 (see FIG. 1) stops. After the piezoelectric motor 610 is stopped, the braking unit 91 may be put either in the first state or in the second state. However, if the braking unit 91 is in the second state, the braking operation of the braking unit 91 is maintained, making it harder for the movable portion 50 to be misaligned.

As described above, with the configuration of the drive device 103 according to the fifth embodiment, further braking capability can be obtained in addition to the braking capability of the piezoelectric motors 610, 620, 630, 640. Even if a large external force is applied, the movable portion 50 will not be easily misaligned.

### Sixth Embodiment

### Drive Device

Next, a drive device according to a sixth embodiment will be described. The drive device according to the sixth embodiment is different from the second embodiment in that the photo-MOS relays are changed to a rotary switch. However, the other configurations are substantially similar. Hereinafter, this embodiment is described mainly in terms of the difference from the foregoing embodiment and description of similar elements is omitted.

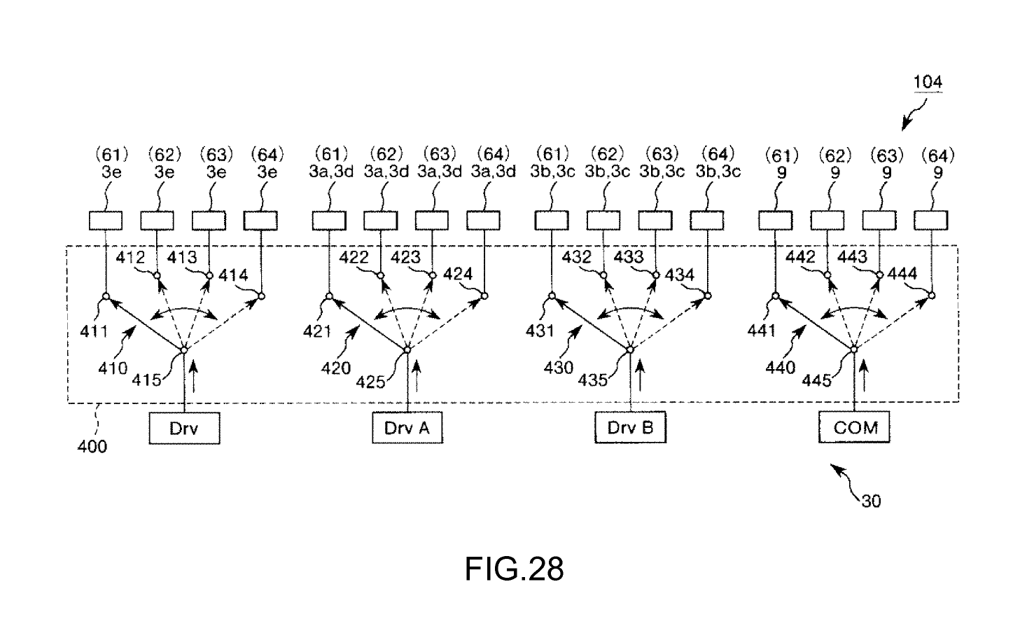

FIG. 28 is a schematic view showing a rotary switch in the drive device according to the sixth embodiment.

In a drive device 104 according to the sixth embodiment, as a connection/disconnection portion, a rotary switch 400 is provided instead of the photo-MOS relays 21, 22, 23, 24 in the second embodiment. While the rotary switch 400 has a four-circuit four-contact configuration, other configurations may also be used. Also, while the rotary switch 400 is to be manually rotated, this configuration is not limiting, and for example, a rotary switch rotated by a drive source such as a motor, or a rotary switch that can be rotated manually and also rotated by a drive source such as a motor, may also be used.

The rotary switch 400 includes a first stage portion 410 having a select terminals 411, 412, 413, 414 and a common terminal 415, a second stage portion 420 having select terminals 421, 422, 423, 424 and a common terminal 425, a third stage portion 430 having select terminals 431, 432, 433, 434 and a common terminal 435, and a fourth stage portion 440 having select terminals 441, 442, 443, 444 and a common terminal 445. As the rotary switch 400 rotationally operates, the first stage portion 410, the second stage portion 420, the third stage portion 430 and the fourth stage portion 440 are interlocked with each other, and in the first stage portion 410, the common terminal 415 is electrically connected sequentially to the select terminals 411, 412, 413, 414. The same applies to the second stage portion 420, the third stage portion 430 and the fourth stage portion 440. When the common terminal 415 is electrically connected to the select terminal 411 in the first stage portion 410, the common terminal 425 is electrically connected to the select terminal 421 in the second stage portion 420 and the common terminal 435 is electrically connected to the select terminal 431 in the third stage portion 430 while the common terminal 445 is electrically connected to the select terminal 441 in the fourth stage portion 440. The same applies to the other terminals.

A longitudinal oscillation drive signal (Dry) is inputted to the common terminal 415 in the first stage portion 410 from the drive circuit 30. Then, the electrode portion 3e of the piezoelectric motor 61 is electrically connected to the select terminal 411. The electrode portion 3e of the piezoelectric motor 62 is electrically connected to the select terminal 412. The electrode portion 3e of the piezoelectric motor 63 is electrically connected to the select terminal 413. The electrode portion 3e of the piezoelectric motor 64 is electrically connected to the select terminal 414. Thus, as the rotary switch 400 rotationally operates, the output portion of the longitudinal oscillation drive signal (Dry) in the drive circuit 30 is electrically connected sequentially to the electrode portions 3e of the piezoelectric motors 61, 62, 63, 64 via the rotary switch 400.

Also, a first bending oscillation drive signal (DrvA) is inputted to the common terminal 425 in the second stage portion 420 from the drive circuit 30. Then, the electrode portions 3a, 3d of the piezoelectric motor 61 are electrically connected to the select terminal 421. The electrode portions 3a, 3d of the piezoelectric motor 62 are electrically connected to the select terminal 422. The electrode portions 3a, 3d of the piezoelectric motor 63 are electrically connected to the select terminal 423. The electrode portions 3a, 3d of the piezoelectric motor 64 are electrically connected to the select terminal 424. Thus, as the rotary switch 400 rotationally operates, the output portion of the first bending oscillation drive signal (DrvA) in the drive circuit 30 is electrically connected sequentially to the electrode portions 3a, 3d of the piezoelectric motors 61, 62, 63, 64 via the rotary switch 400.

Also, a second bending oscillation drive signal (DrvB) is inputted to the common terminal 435 in the third stage portion 430 from the drive circuit 30. Then, the electrode portions 3b, 3c of the piezoelectric motor 61 are electrically connected to the select terminal 431. The electrode portions 3b, 3c of the piezoelectric motor 62 are electrically connected to the select terminal 432. The electrode portions 3b, 3c of the piezoelectric motor 63 are electrically connected to the select terminal 433. The electrode portions 3b, 3c of the piezoelectric motor 64 are electrically connected to the select terminal 434. Thus, as the rotary switch 400 rotationally operates, the output portion of the second bending oscillation drive signal (DrvB) in the drive circuit 30 is electrically connected sequentially to the electrode portions 3b, 3c of the piezoelectric motors 61, 62, 63, 64 via the rotary switch 400.

Moreover, a common signal (COM) is inputted to the common terminal 445 in the fourth stage portion 440 from the drive circuit 30. Then, the common electrode 9 of the piezoelectric motor 61 is electrically connected to the select terminal 441. The common electrode 9 of the piezoelectric motor 62 is electrically connected to the select terminal 442. The common electrode 9 of the piezoelectric motor 63 is electrically connected to the select terminal 443. The common electrode 9 of the piezoelectric motor 64 is electrically connected to the select terminal 444. Thus, as the rotary switch 400 rotationally operates, the output portion of the common signal (COM) in the drive circuit 30 is electrically connected sequentially to the common electrodes 9 of the piezoelectric motors 61, 62, 63, 64 via the rotary switch 400.

In this manner, through the rotational operation of the rotary switch 400, the drive signal from the drive circuit is selectively supplied to the piezoelectric motor electrically connected to the drive circuit 30, of the piezoelectric motors 61, 62, 63, 64.

As described above, with the configuration of the drive device 104 according to the sixth embodiment, compared with the case where the connection/disconnection portion is formed by photo-MOS relays, the rotary switch 400 can be manually rotated so that one of the piezoelectric motors 61, 62, 63, 64 and the drive circuit 30 can be selectively connected easily, even in the case where a select signal to operate the photo-MOS relays cannot be outputted, for example, at the time of maintenance or adjustment of the device.

While the rotary switch is provided in this embodiment instead of the photo-MOS relays in the second embodiment, the invention is not limited to this configuration. For example, photo-MOS relays and a rotary switch may be used in parallel.

The drive device, the electronic component carrying device, the electronic component inspection device, the robot hand and the robot according to the invention are described above, based on the illustrated embodiments. However, the invention is not limited to these embodiments and the configuration of each part can be replaced with any configuration having similar functions. Moreover, other arbitrary components may be added to the invention.

Also, the invention may include a combination of any two or more configurations (features) of the embodiments.

In the first embodiment, encoder signals are fed back to the drive circuit 30 separately from the individual encoders 51, 52, 53, 54 provided for the piezoelectric motors 11, 12, 13, 14. However, this configuration is not limiting. Plural relays may be provided on the encoder side and the encoders 51, 52, 53, 54 may be switched by the relays. Alternatively, the encoders 51, 52, 53, 54 may convert signals into serial signals or encode signals and then feed the signals back to the drive circuit 30, and the drive circuit 30 may convert the signals into parallel signals or decode the signals. By employing such a configuration, the number of wires between the drive circuit 30 and the encoders 51, 52, 53, 54 can be reduced.

Also, while the digital amplifier 34 is used in the drive circuit 30 in the first embodiment, this configuration is not limiting. An analog amplifier may be used in the drive circuit 30. If an analog amplifier is used in the drive circuit 30, the PWM unit 33 and the inductor-capacitors 35, 36 are eliminated.

Also, according to the invention, the number of piezoelectric motors in the drive unit may be any plural number.

Moreover, according to the invention, the number of drive circuits in the drive unit may be any number that is smaller than (fewer than) the number of piezoelectric motors, and may be for example, a plural number.

Also, while piezoelectric motors are used in the foregoing embodiments, the invention is not limited to this configuration and may use, for example, various DC motors or AC motors.

Also, while the number of arm members in the arm portion of the robot in the foregoing embodiment is two, the invention is not limited to this configuration. The number of arm members in the arm portion of the robot may be one or may be three or more.

Moreover, while the robot in the foregoing embodiment is a two-arm robot (multiple-arm robot) having two arm portions, the invention is not limited to this configuration. For example, a single-arm robot having one arm portion, or a multiple-arm robot having three or more arm portions may also be employed.

Also, the robot of the invention is not limited to an arm-type robot (robot arm) and may be other types of robots, for example, SCARA robot, legged walking robot (running robot) or the like.

Moreover, the drive device of the invention can be applied not only to the electronic component carrying device, the electronic component inspection device, the robot hand and the robot, but also to other devices, for example, other carrying devices, other inspection devices, component processing devices, mobile bodies and the like.

The entire disclosure of Japanese Patent Application No. 2013-115022 filed May 31, 2013 is expressly incorporated by reference herein.

What is claimed is:

1. A drive device comprising:
a plurality of movable members;
motors operatively associated with the movable members and so as to selectively move the moving members;
at least one drive circuit that drives the motors; and
a connection/disconnection portion that connects and disconnects the motors to/from the drive circuit;
wherein fewer of the drive circuits are provided in the device than the motors.

2. The drive device according to claim 1, wherein the motors are piezoelectric motors.

3. The drive device according to claim 1, further comprising a braking unit operatively associated with the movable members so as to selectively brake movement of the movable members.

4. The drive device according to claim 1, wherein two or more of the drive circuits are provided.

5. The drive device according to claim 1, wherein the movable members have different moving directions from one another.

6. The drive device according to claim 1, wherein the movable members include:
a first movable member that is movable in a first moving direction,
a second movable member that is movable in a second moving direction orthogonal to the first moving direction, and
a third movable member having a rotation axis in a direction orthogonal to each of the first and second moving directions.

7. The drive device according to claim 6, further comprising:
a base movably supporting the first movable member, and
wherein the third movable member is arranged between the first movable members and the second movable members.

8. The drive device according to claim 1, wherein the connection/disconnection portion is operatively provided between each of the motors and the at least one drive circuit.

9. The drive device according to claim 1, wherein the connection/disconnection portion has a photo-MOS relay.

10. The drive device according to claim 1, wherein the connection/disconnection portion has a rotary switch.

11. An electronic component carrying device comprising:
a gripper adapted to selectively grip an electronic component;
a plurality of movable members operatively associated with the gripper so that the gripper may be manipulated;
motors provided on the movable members, the motors being configured to selectively move the movable members;
at least one drive circuit that drives the motors; and
a connection/disconnection portion that connects and disconnects the motors to/from the drive circuit;
wherein fewer of the drive circuits are provided in the device than the motors.

12. The electronic component carrying device according to claim 11, wherein the motors are piezoelectric motors.

13. The electronic component carrying device according to claim 11, wherein the plural movable members include:
a first movable member that is movable in a first direction,
a second movable member that is movable in a second direction orthogonal to the first direction, and
a third movable member having a rotation axis in a direction orthogonal to each of the first and second moving directions.

14. The electronic component carrying device according to claim 13, further comprising:
a base movably supporting the first movable member, and
wherein the third movable member is arranged between the first movable member and the second movable member.

15. An electronic component inspection device comprising:
an inspection portion that inspects an electronic component;
a gripper adapted to selectively grip the electronic component;
a plurality of movable members operatively associated with the gripper so that the gripper may be manipulated;
motors provided on the movable members, the motors being configured to selectively move the movable members;
at least one drive circuit that drives the motors; and
a connection/disconnection portion that connects and disconnects the motors to/from the drive circuit;
wherein fewer drive circuits are provided in the device than the motors.

16. The electronic component inspection device according to claim 15, wherein the motors are piezoelectric motors.

17. The electronic component inspection device according to claim 15, wherein the plural movable members include:
a first movable member that is movable in a first direction,
a second movable member that is movable in a second direction orthogonal to the first direction, and
a third movable member having a rotation axis in a direction orthogonal to each of the first and second moving directions.

18. The electronic component inspection device according to claim 17, further comprising:
a base movably supporting the first movable member, and
wherein the third movable member is arranged between the first movable member and the second movable member.

19. The drive device according to claim 1, wherein
the drive device comprises a robot hand;
the movable members are a plurality of rotatable fingers; and
the motors rotate the fingers.

20. The robot hand according to claim 19, wherein the motors are piezoelectric motors.

21. The drive device according to claim 1, wherein
the drive device comprises a robot;
the movable members are a plurality of rotatable arms; and
the motors move the arms.

22. The robot according to claim 21, wherein the motors are piezoelectric motors.
